(19) United States
(12) Patent Application Publication
(10) Pub. No.: US 2025/0166294 A1
(43) Pub. Date: May 22, 2025

(54) METHODS FOR GENERATING AND USING EXTENDED REALITY SPACES WITH PHYSICAL SPACES

(71) Applicant: Avrio Analytics LLC, Knoxville, TN (US)

(72) Inventors: Michael G. Bertolli, Knoxville, TN (US); Alicia R. Caputo Bertolli, Knoxville, TN (US)

(73) Assignee: Avrio Analytics LLC, Knoxville, TN (US)

(21) Appl. No.: 18/768,601

(22) Filed: Jul. 10, 2024

Related U.S. Application Data
(60) Provisional application No. 63/568,663, filed on Mar. 22, 2024.
(60) Provisional application No. 63/566,644, filed on Mar. 18, 2024.
(60) Provisional application No. 63/560,317, filed on Mar. 1, 2024.
(60) Provisional application No. 63/610,017, filed on Dec. 14, 2023.
(60) Provisional application No. 63/578,277, filed on Aug. 23, 2023.
(60) Provisional application No. 63/514,697, filed on Jul. 20, 2023.
(60) Provisional application No. 63/512,724, filed on Jul. 10, 2023.
(60) Provisional application No. 63/512,727, filed on Jul. 10, 2023.

(51) Int. Cl. G06T 17/00

(52) U.S. Cl. CPC G06T 17/00

(57) ABSTRACT

A system and method for generating XR content, where a spatial abstraction of a first physical space having a first physical arrangement is performed. The spatial abstraction process identifies and represents portions of the first physical arrangement as a first group of one or more digital components. The digital components are represented as code that is suitable for use by an XR generation system (XGS) to generate XR content for a plurality of physical spaces and a plurality of physical arrangements. Those physical spaces and physical arrangements each include corresponding portions that may each be represented by the one or more digital components. Then, with an XGS, XR content is generated for the corresponding portions of the at least one physical space.

### CROSS-REFERENCE TO RELATED APPLICATIONS

This application claims the benefit of each of the following: U.S. Provisional Application No. 63/512,724, filed Jul. 10, 2023, titled “Constrained Procedural Environment Generation in Physical Spaces”; U.S. Provisional Application No. 63/512,727, filed Jul. 10, 2023, titled “Zero-shot Localization from Feature-Poor Spatial Descriptors”; U.S. Provisional Application No. 63/514,697, filed Jul. 20, 2023, titled “Semantic Shared Spatial Mapping”; U.S. Provisional Application No. 63/578,277, filed Aug. 23, 2023, titled “Method for Communicating Information”; U.S. Provisional Application No. 63/610,017, filed Dec. 14, 2023, titled “Evolutionary Analysis of Cohorts for Adaptive Attribute Determination”; U.S. Provisional Application No. 63/560,317, filed Mar. 1, 2024, titled “Semantic Shared Spatial Mapping in Non-Co-Located MVAR Experiences”; U.S. Provisional Application No. 63/566,644, filed Mar. 18, 2024, titled “A System for Generating XR Content and Enabling XR Experiences Through Space-as-Code”; and U.S. Provisional Application No. 63/568,663, filed Mar. 22, 2024, titled “Privacy-Preserving Semantic Matching in Disparate Physical Environments”; the entire content of each of the foregoing applications is incorporated herein in its entirety.

### FIELD

This invention relates generally to methods of mapping unknown physical spaces for use in the presentation of XR content and to methods of generating and presenting XR content in known physical spaces.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

As used herein, the term “agent” generally means a system or entity within an environment that may or may not act within or in response to the environment, such as by taking actions based on its state and the environment's state. More broadly, an “agent” is “an actor” or “entity” in an environment that may be a computer system, a robot, a human, etc.

“Assets” include inanimate XR content (e.g., furniture) or animate XR content (e.g., enemies used in video game creation).

“Experiences” can mean procedurally generated XR “environments” or “levels” as well as non-procedurally generated (i.e., pre-generated or pre-determined) environments or levels. However, more generally, the term refers to procedurally generated XR experiences with spatial constraints. The assets generated may include, either individually or as a combined experience, additional experiential concepts. For example, generation may result in certain sensations of suspense or urgency. But rather than those being the ancillary effects, these may in fact be core to the procedural design or may be considered assets themselves. In generated XR experiences with certain design objectives and where the content generated is influenced by optimization towards design objectives, those objectives can certainly include achieving experiential concepts or particular sensations, including cognitive, psychosomatic, psychological or physical sensations.

“One-shot localization” means a localization method that relies on a minimum level of “visual” data collection from the observation of a physical space. In such cases, an agent has “seen” the physical space, directly or indirectly, at least once before the localization inference takes place. As used above, the term “visual data” is construed broadly to include a variety of data sources, including particularly pictures and videos in the electro-magnetic spectrum. Conversely, the term “zero-shot localization” means a localization method that occurs with a minimal spatial representation of the space and the agent “seeing” the space only once (i.e., at the time of localization) and not prior to localization. As such, zero-shot localization does not require the agent to have seen the physical space at all or to even be provided with an accurate representation of it. Instead, zero-shot methods can rely on mere descriptions (e.g., written or verbal) of a physical space. As the term is used herein, zero-shot localization occurs when the system, using a localizing agent, can locate itself within a space under the following conditions:
1. localizing agent only has access to a non-oriented map of the location, which need not share a coordinate system with the localizing agent;
2. neither the localizing agent nor the map have means to a priori transform between its own coordinate system and the other coordinate system, including access to external observations or data that would allow for the creation of such a transform between the two relevant coordinate systems;
3. localizing agent only has access to local, contemporaneous observations of the space and does not have access to prior collections of observations of the space (i.e., cannot have been in the space before or otherwise receive data from some other source that has been in the space before) other than the non-oriented map; and
4. localizing agent and non-oriented map do not have access to external observations or data that would allow for the creation of a transform between the two relevant coordinate systems (e.g., compass orientations, GPS, etc.).

As the term is used here, “semantic” refers to the meaning and interpretation of data, symbols, language, instructions, etc. It is from the Greek for “meaning” and is the underlying meaning or “what something is.” Generally, this term is used as a way of describing or defining something, but it is not a hard physical attribute (e.g., not the size, shape, color or material of it, etc.). Instead, what “something is” can be quite broad. For example, it might mean the object's “function” or “use,” such as how a bunch of fabric and wood assembled geometrically in certain ways “is a couch.” The description of it from geometry, materials, etc. are not semantic, but calling it a “couch” is (or even calling it a “thing upon which to sit” would be semantic). Similarly, the term “semantic” should not be limited to an object's function only. One might equally take an existentialist approach, for example, by semantically defining the above-described assembly of fabric and wood by its existence (e.g., “has been here for years” or “was recently purchased”). These are semantic descriptions. In other cases, a classical approach may be used, where the thing's purpose defines it. In more specific cases, the term “semantic” may mean the description or definition of how one might interact with something in an experience. This might be, for example, the object's age, function, usage, whether it can be used (e.g., “is in play” or “is openable” for a door), or even its philosophical underpinnings (e.g., how we might semantically describe artifacts in a museum, relating to interactions around historical impact), etc.

“Spatial analysis” is an additional step in the procedural development process for XR content generation that is applied to the physical layout prior to generation or algorithm learning/development. This step might include analyzing the physical space, including either a model or digital twin (i.e., a digital equivalent), and then saving or using the results of that analysis to inform the procedural generation. Such analysis might include (1) semantic segmentation including statistics of the semantics via computer vision or analyzing surface normal or other information to indicate the semantic nature of objects and surfaces (e.g., enumerating the number of windows or chairs in a space once semantic information is known); or (2) volumetric and surface analysis (e.g., determining the square footage of floor or walls, counting the number of rooms, calculating the volume of the space). Spatial analysis might also include an analysis of the angle of surfaces, distance between points (e.g., farthest points in the space, or farthest by room) and the like.

“Spatially directed generation” relates to certain assets, design objectives or experiences that require, or benefit from, being directed by the physical spatial constraints directly. For example, certain events, interactions, visuals, sensations or even narrative goals might be best generated in the physically largest room in the layout (where “largest” can be defined appropriately for the use-case), such as making that room the “bridge” of an XR “spaceship.” This provides a more specific spatial constraint on the generation that we term “spatially directed.” This is because it not only provides some level of specification on what is generated in the largest room but can also provide critical specification on what is generated elsewhere such that the user is guided (e.g., visually or through interactions) to the largest room appropriately. In some cases, this spatial direction has implications on how design or other objectives are achieved because it places an additional constraint on the content or participant.

“Library” mean XR assets that are available as building blocks for use in generating XR content and environment. The library can be dynamically generated or pre-generated.

“Foundational Assets” means XR assets that are the “atomic” building blocks of procedural content that cannot be subdivided or created from a combination of other atomic assets. Foundational assets may include textures, props, 3D model components, audio, text, narrative, visual effects, sound effects, animation, or other virtual components. Foundational assets may also include the “thing” that creates or generates assets. For example, a foundational asset may be an algorithm or method that can generate textures, props, etc., because and so long as such a “thing” remains atomic.

“Composite Assets” are assets that are created by combining one or more foundational or composite assets.

“Theme” is the target “look” or “feel” for an XR environment, ranging from a very specific description (e.g., “medieval tavern with high contrast lighting in a horror narrative”) to a generic description (e.g., “sci-fi spaceship”).

The term “physical space” is used interchangeably with “physical environment” to identify the physical location where XR content is experienced by a user.

The term “algorithm” is used to refer to a process or a sequence of steps that are carried out, generally by a computer, to accomplish a certain objective.

The term “baseline physical function” means an interaction or the type or manner of an interaction occurring between a (1) physical environment and (2) XR content or user.

The term “game mechanic function” means an interaction or the type or manner of an interaction occurring between (1) a user or first XR content and (2) second XR content.

### BACKGROUND

A virtual reality (“VR”) environment is one that provides total immersion of the user without introducing elements of the user's actual environment. Any interactions occur entirely within the virtual environment and not within the physical world. Typically, a VR environment is created using computer-generated or real images. The term “peripheral” or “XR peripheral” is used to refer to the tools (e.g., gloves, goggles, helmets, etc.) that a user might employ to view and interact with that XR environment. Peripherals, such as gloves, goggles, controllers, etc. (i.e., “peripherals”), detect the user's movements, typically including movement of the user's head and hands, translate that movement into the virtual environment to allow the user to interact with the VR environment. On the other hand, an AR environment is one where data (e.g., computer-generated experiences, information, etc.) are overlaid onto the physical world, but where all interactions occur within the physical world. Typically, AR environments use a display screen, glasses, goggles, etc. to present the data. A mixed reality (“MR”) environment is essentially a combination of VR and AR environments, where virtual objects are integrated and interact with the physical world in real time. Like VR, MR peripherals may also be used in connection with MR environments, which devices are typically specifically manufactured for direct connectivity and interaction with the environment created. Finally, an extended reality (“XR”) is used as an umbrella or catchall term that includes AR, VR, MR. In the description that follows, the term “XR” or the phrase “extended reality” may be used to refer to any of AR, VR, or XR unless otherwise specifically noted. The term “XR system” refers to the computer, machine, etc. that displays or serves up the virtual content or experience for an XR environment, such as a display or XR goggles. On the other hand, the term “XR generation system” or “XGS” is the computer, machine, etc. that generates the XR content. In certain cases, the XR system includes an XGS, such as where an XR headset includes an onboard means for generating XR content. However, in other cases, XR content is generated by an XGS and is then separately provided to one or more XR systems. Virtual reality (VR), augmented reality (AR), mixed reality (MR), and extended reality (XR) systems (collectively and individually, each an “XR” system unless specifically expressed otherwise), as further defined below, are helpful in providing realistic training, entertainment, and other experiences.

XR content, especially AR content, is conventionally produced using individual assets that are generated and made available for use by developers or users that select and place those assets in a given space. Until selected and placed within the given space by developers or users, these assets generally have no understanding, concern, or information about that space or about any other space. As such, the placement and assignment of these assets within a given space is labor intensive and the work used in placing these assets for one project is generally not applicable to other projects. This impedes and frustrates the development of XR content and the labor-intensive process of placing these assets occurs on a project-by-project basis. While this solution might be acceptable when a single player is interacting with the content and where that content is built for that user's space, it may not be acceptable in instances where multiple user's wish to experience the same or a similar XR experience in separate and different environments.

What is needed, therefore, is a method for developing XR content for variety of physical spaces where the assets used in that development process may be used in a variety of physical spaces having differing physical configurations or layouts.

### SUMMARY OF THE INVENTION

The above and other needs are addressed by a method for generating XR content. The method includes performing a spatial abstraction of a first physical space having a first physical arrangement by identifying and representing portions of the first physical arrangement as a first group of one or more digital components. In certain embodiments of the method, a scanner is associated with the XGS to perform a three-dimensional scan of the first physical space prior to performing the spatial abstraction, and the spatial abstraction is performed on the three-dimensional scan. The first group of one or more digital components is represented as code suitable for use by an XR generation system (XGS) to generate XR content for a plurality of physical spaces and a plurality of physical arrangements that each include corresponding portions that may each be represented by the one or more digital components. Next, with an XGS, XR content is generated for the corresponding portions of the at least one physical space. In certain cases, the at least one physical space includes the first physical space such that the XR experience is generated for the first physical space and the first physical arrangement. In certain cases, the at least one physical space does not include the first physical space, such that the XR experience is generated for a physical space and a physical arrangement other than the first physical space and the first physical arrangement.

In certain cases, the method includes providing the XR content to a first user. In certain cases, the method includes providing the XR content to the first user and to a second user that are each co-located at a physical space. In certain cases, XR content is generated for at least a first physical space and a second and different physical space. Certain instances of the method further include providing the XR content to a first user located in the first physical space and a second user located in the second physical space.

Certain embodiments of the method include providing a plurality of spatial modules that each govern an interaction with a digital component. The spatial modules may form a library of pre-defined spatial modules that may each be selectively chosen and applied to each digital component when generating the XR content. In certain cases, the XGS automatically selects and applies a spatial module to at least one digital component. In certain cases, at least one of the plurality of spatial modules governs a baseline physical function of the digital component. In certain cases, at least one of the plurality of spatial modules governs a game mechanic function of the digital component.

In certain embodiments, the code includes information related only to the one or more digital components and does not contain information related to a position or orientation of the first physical arrangement or a position or orientation of any other physical arrangement such that the one or more digital components are universally applicable to each of the plurality of physical spaces and plurality of physical arrangements.

In certain embodiments, the method includes providing a plug comprising an encoding that is based on the one or more digital components and that lacks physically identifiable data related to any physical space. Additionally, in such cases, the method includes providing a plurality of receptacles that are each configured to accept the plug and that are each comprised of an interaction layer that governs an interaction between (1) the at least one physical space, a user, or a first portion of the XR content and (2) a second portion of the XR content. In certain cases, the encoding includes a base layer defining an abstracted geometry of the at least one physical space and represented by the one or more digital components. In certain cases, the encoding of the plug includes at least one of: (1) a dimensional layer for encoding spatial relationships of the one or more digital components of the encoding, (2) a semantic layer for providing semantic information of the one or more digital components of the encoding, and (3) a mechanic layer for providing spatial mechanic information specifying at least one of materials or behavior of the one or more digital components of the encoding. In certain cases, at least one of the plurality of receptacles includes a mechanic layer for providing spatial mechanic information specifying at least one of materials or behavior of the one or more digital components of the encoding. In certain embodiments, the mechanic layer of the plug fully matches the mechanic layer of the at least one of the plurality of receptacles such that an entirety of the at least one of materials or behavior specified by the mechanic layer of the at least one of the plurality of receptacles is accessible to the plug. However, in other cases, the mechanic layer of the plug partially matches the mechanic layer of the at least one of the plurality of receptacles such that only a portion of the at least one of materials or behavior specified by the mechanic layer of the at least one of the plurality of receptacles is accessible to the plug.

In certain cases, the method includes providing an interpreter configured to convert the one or more digital components to XR content suitable tailored for the at least one physical space. In certain cases, the method further includes the step of, with the runtime interpreter, receiving a space-as-code (SAC) instruction for creating the XR content. In such case, the method further includes, in generating the XR content and in response to the SAC instruction, using to the runtime interpreter to translate the one or more digital components to corresponding physical equivalents. Further, the method includes, using the runtime interpreter, identifying the corresponding physical equivalents in the at least one physical space and then generating the XR content based on the identified corresponding physical equivalents.

In certain cases, the present disclosure provides a system for generating and providing XR content to a user. The system is configured to perform a spatial abstraction of a first physical space having a first physical arrangement by identifying and representing portions of the first physical arrangement as a first group of one or more digital components. The first group of one or more digital components is represented as code suitable for use by an XR generation system (XGS) to generate XR content for a plurality of physical spaces and a plurality of physical arrangements but that each include corresponding portions that may each be represented by the one or more digital components. Then, using the code, XR content is generated for the corresponding portions of the at least one physical space. Finally, an XR content output is configured to output the XR content to a user.

### BRIEF DESCRIPTION OF DRAWINGS

FIG. 1 depicts a mapped space having a mapped node that is hypothesized to correspond to an observed node in a physical space;

FIG. 2 depicts an intersection of a first wall with a second wall that provides a first node and also depicts a corresponding intersection angle between the walls;

FIG. 3 depicts pairs of perpendicular lines extending through nodes of a physical space that may or may not intersect with other lines, where the presence or absence of intersection may be considered a property of each node that permits each of the nodes to be related to one another and for them to be graphed and related to one another;

FIG. 4 is a graphical representation or result of drawing the perpendicular pairs of lines shown in FIG. 3;

FIG. 5 illustrates a map having multiple observed nodes, including nodes nₐ and n_{b};

FIG. 6 depicts a pair of maps representing the same space, including a well-drawn map and a poorly drawn map;

FIG. 7 depicts three nodes n₁, n₂, and n₃ and two time-ordered approach sequences through a given space by an agent;

FIG. 8 depicts a highly symmetric map that lacks distinct features;

FIG. 9 is a visual representation of a result of a spatial abstraction process;

FIG. 10-12 depict graphs of Information Scenarios (IS) according to embodiments of the present invention;

FIG. 13 depicts an experience having an IS formed by a content volume (CV) or simulation event (SE);

FIG. 14 depicts an image of a room containing a desk and a chair that is divided into a plurality of characteristic cells according to an embodiment of the present invention;

FIGS. 15 and 16 depict images of large and small characteristic cells that have been painted to cause the desk and chair of FIG. 14 to have the appearance of Egyptian sarcophagus;

FIG. 17 depicts space obfuscation of a large space according to an embodiment of the present invention;

FIG. 18 depicts space expansion of the large space of FIG. 17;

FIG. 19 depicts two users in separate physical spaces engaging in a shared XR experience according to an embodiment of the present invention;

FIG. 20 depicts a grid-based example of possible paths from the user's current location X by a TABLE semantic anchor to either a COUCH semantic anchor or a DOOR semantic anchor;

FIG. 21 depicts a pair of environments that have different physical arrangements of anchors and avatars placed in those environments that are navigating between the anchors;

FIG. 22 depicts an exchange of information using encryption methods according to embodiments of the present invention;

FIG. 23 depicts a layered encoding (i.e., plug) and a corresponding interaction layer (i.e., receptacle) that visually represents a spatial abstraction process used in connection with a Space as Code process for creating XR content; and

FIGS. 24 and 25 depict a pair of unique layered encodings that each work in connection with the same receptacle.

### DETAILED DESCRIPTION OF THE INVENTION

In each of the cases described in the Background above, knowledge of a physical space where XR content is consumed or experienced or a lack of such knowledge can determine whether XR can be generated and presented to a user, whether it can be presented accurately, the nature of the XR content presented, the nature of the XR experience, etc. Accordingly, whether that physical space is known or not is an important factor in determining the nature of XR content and its consumption. In the description below, various methods for generating and using XR spaces with physical spaces is provided, including when the surrounding physical space is known or not known. In particular, Part I presents localization methods that may be used in quickly and accurately determining a location and orientation of an XR system or XR peripheral within a physical environment where only limited or incomplete data about that physical is available. Then, in Part II, methods for generating and placing XR content in a known and mapped physical space are provided. Lastly, methods for addressing several issues that arise when multiple participants wish to share XR experiences in a known physical space are presented in Part III.

Part 1: Localization and Orientation within Unknown Spaces

Localization (e.g., orienteering) within a physical space is a key part of spatial tracking, such as that done for autonomous robots, XR peripherals, and other systems. While maps of locations may be available, the maps are only useful if the mapped coordinates (or features) they provide can be translated and made relevant to the coordinate system of the relevant system (e.g., the XR system). For that reason, localization using a map or other similar guide means, whether by a system (e.g., a computer system) or a human, requires data from the real (i.e., physical) environment that can be correlated to map data as well as position and movement tracking relative to a designated origin or other selected point of interest. For example, in the case of a human following a map, the individual might recognize and match visual features of a landscape to corresponding features on the map. Similarly, a navigation system might match environmental features or identifiers that are captured with a sensor (e.g., camera, LiDAR, etc.) to previously stored “maps” that include similar types of features or identifiers (or data with a known translation to the previously collected information, e.g., point clouds from LiDAR data). As an example, and without limitation, contextual data used in localization may include GPS data, elevation data, or prior knowledge of the environment (e.g., a vacuum robot may assume a “home” location at a given position).

In certain cases, especially in AR, the localization problem may be solved by correlating GPS data with visual data. In those cases, initially, GPS data allows the device (e.g., smartphone) to be localized in a relatively precise location on a map, such as at a specific street corner in a city. Then, to refine the location and orientation of the device, such as to provide walking instructions, additional data (e.g., camera data) may be periodically collected and used to further identify and update the location of the device (e.g., the location of nearby building facades relative to the device). While this process is straightforward when using readily available GPS map data, acquiring similar data in unknown locations such as inside buildings complicates this process. Other similar processes may use other types of sensor data, e.g., LiDAR or infrared imagery, but suffer the same limitation of requiring substantial, already observed and mapped data that corresponds to observable data. Thus, localization is currently performed using prior experiences of the physical space to construct a suitable feature-rich map; therefore, this is a “one-shot” localization process, at best, where the matching process relies on matching data to other data that was previously collected by a device while located in the relevant space at least one previous time or where data is received from a device that was previously located in the relevant space at least one previous time (i.e., may be different devices).

Next, since one spatial map can look similar to many other spatial maps, accurate localization often requires large amounts of data to be observed and available for unique mapping. As such, problems arise in the localization process if data is lacking in either the map or the observation of the physical environment. For example, if provided with only a poor map of the interior of a building, a robot may struggle to localize itself in that environment (i.e., to identify a unique position in the environment that corresponds to a unique position on the map), even if provided with an array of sensors. In such a case, the robot may only be capable of localizing itself after remapping the building such that the data available is sufficient to provide a unique match. In such cases, it may be possible, using techniques like Simultaneous Localization and Mapping (SLAM), for an agent to self-locate using a map created on-the-fly (i.e., where localization is through “remembering” features to allow for positioning and rotational tracking). However, such processes do not solve the problem of localization against a predefined but deficient external map. For example, when a “mall map” provides the locations of points of interest but fails to provide a “you are here” indicator. Such a map provides the rough locations of points of interest but requires self localization. This may be termed a “feature-poor” mapping of the physical space. Accordingly, there's a need for robust localization in environments where either there is either insufficient map data, observational data, or both.

Methods according to the present invention allow for a “zero-shot localization” to occur, even when provided with only feature-poor mapping. This method takes advantage of the observation of primitive geometric features, namely real or imaginary points of intersection in space, to carry out the localization process. While this process is not limited to any specific space, spaces having obvious intersections (e.g., corners), such as those inside of buildings, are better suited for this method. As such, in the discussion below, the interior of a building is used as a non-limiting illustrative example for carrying out these methods. Each of the following methods seeks to orient an agent within an unknown space by comparing observed locations in the physical space (i.e., “observed” nodes) against locations that are found on the map (i.e., “mapped” nodes). In this respect, the methods mimic human orienteering (e.g., where a human recognizes the layout of a foyer as indicating an entry/exit point without requiring the prior observation or a sign denoting it) more than common autonomous localization.

These methods allow for extremely rapid localization to occur in areas where extremely limited data is available, such as indoors with only a floor plan. The observations required are readily achievable on common systems and can achieve robust localization by exploiting commonly occurring asymmetries and geometric graph structures in both man-made and natural environments. This reduces or removes the need for extensive prior mapping or localizing observation collection. For example, in certain cases, only a floor plan may be needed to carry out this process and with no additional visual or geospatial information. Suppose an instructor builds a training scenario on a digital floor plan and then marks a corner as the spatial “anchor” for that scenario (described further below). Conventionally, the user in an AR headset must then mark (i.e., locate) the corresponding corner in the physical world to match the physical location to the digital map. As such, the location marked by a first user must be the same as the location marked by a second user. However, with the current methods, the headset user can be guided, a priori (i.e., independent of any experience), to the corner located in the physical space that most likely corresponds to the anchor corner of the map. Preferably, this matching process is carried out automatically for the user. In this method, the map used may be a description only (i.e., including written or verbal descriptions) that may or may not include any direct collection of the space's data.

A first method relies on primitive geometric features (e.g., intersections) that are present in the space. These intersections create unique points in physical or imaginary space that may be used to construct a collection of points and to define their relationships in a graphical structure. With respect to “imaginary” spaces or features thereof, some of the intersections may not actually be physically present (i.e., an intersection between walls does not exist); instead, they might be projected intersections such those formed by intersecting lines that are projected away from corners along imaginary lines. In certain cases, imaginary intersections may even be located partially or entirely outside of a given physical space (e.g., building).

These methods remain functional, usable, and informative even if the condition that points be generated from intersections is relaxed. That is, the methods described herein remain valid for collections of points that are derived from things other than intersections. For example, the points arising from intersections might be a subset of all collected points if the condition is relaxed to include points not derived from intersections. The intersection points between these primitive geometric features provide “nodes” and then their edges may define various relationships. Examples of primitive geometric features are provided below in Paragraph [81]. The intersection of geometries, especially planes (e.g., walls), can be easily calculated using well-known and provably accurate methods. Various methods also exist for detecting other points in space, where intersections are not used (or are not used exclusively). In certain cases, nodes may be arranged by their relative locations (i.e., as on a map) and descriptions such as “up by x units and to the left by y units” may be used to describe their relative positions. Alternatively, in a more traditional graph approach, edges may connect nodes that satisfy certain relative spatial associations such as “within z units distance.” Not all edges need to define the same type of relationship. For example, other edges may require spatial associations between nodes such as “z units to the right/down.” The language above implies some a priori orientation that may or may not be known.

From a graph theoretic stance, the intersections reside in a network and, more specifically, in a “neighborhood,” which provides the context for the localization process. At the simplest level, the localization method is based on observing points on a graph and then hypothesizing that a selected node n that has been observed is the mapped point n′ based on the available properties of n, n′, and their respective neighbors. In this example, let: N_{G}={n₀, . . . , n_{N}} be the set of all nodes in the graph of the map. Next, N_{Obs}={n₀, . . . , n_{N}_{_{Obs}}} be the set of all nodes observed by the agent at any given time, or already observed before that time. Then, let: S={N_{Sim}⁰, . . . , N_{Sim}^{N}^{_{Obs}}} be the set of similar sets for each observed node in N_{Obs}, where N_{Sim}ⁱ={n₀, . . . , n_{N}_{_{Sim,i}}} is the set of nodes in N_{G} that are at least some threshold ESim similar to the ith element of N_{Obs}, an observed node. Because two nodes nᵢ and nᵢ may share in common one or more elements in their respective sets N_{Sim}ⁱ and N_{Sim}^{j}:U=N_{Sim}⁰∪ . . . ∪N_{Sim}^{N}^{_{Obs}}∀N_{Sim}∈S, which is the set of pairwise distinct nodes in S.

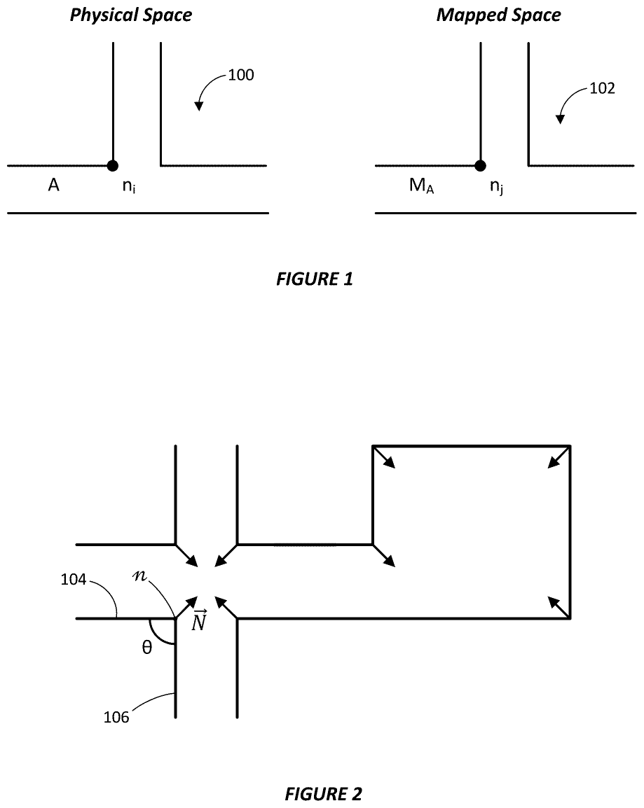

According to one method, an agent may observe a node nᵢ, the properties of this node, pᵢ, are assumed to be either directly observed or derived from the node's relationships within the full set of observed nodes N_{Obs} or within some neighborhood that is a subset of N_{Obs}. From pᵢ it is possible to calculate the similarity of nᵢ to all nodes in the map N_{G}. Various methods for node similarity exist and any may be appropriate, including for example the Naive Bayes classifier, the Jaccard index, or the like. Those nodes in N_{G} that satisfy a selected similarity threshold constitute the set N_{Sim}ⁱ={nⱼ∈N_{G}:f_{Sim}(nᵢ,nⱼ)≥ϵ_{Sim}}, where f_{Sim}(nᵢ, nⱼ) is the similarity between nᵢ and nⱼ. With reference to FIG. 1, it is hypothesized that the observed node, nᵢ, which is found in physical space 100, corresponds to the mapped node, nⱼ, which is found in mapped space 102. In other words, it is hypothesized that the position of the node (i.e., intersection point) in the physical world, nᵢ, and the agent location, A, correspond to mapped location, nⱼ, relative agent location M_{A}, respectively. If true, the agent's location A on the map corresponds to its relative location M_{A}. However, it is necessary to validate that nᵢ=nⱼ is likely true. Here, we are attempting to correlate the map with the physical world, so if nᵢ=nⱼ (i.e., the observed or real-world node matches the mapped node) then we have a sound method of alignment. This is similar to methods of using certain selected points in space to anchor coordinate systems between XR peripherals (e.g., XR headsets). Once a point of alignment has been selected or identified, the agent's location in the real world (as determined by itself, for example) is the equivalent of the other position M_{A} in the mapped world—thus orienting the agent in the map. A primary goal of the above-described procedure is to allow the usual anchoring method of alignment (e.g., using a point in space defined by a corner), where the corner being used is generally defined by a person setting up the experience in a digital floorplan (e.g., an instructor). Conventionally, the instructor might tell the user which corner to use in this anchoring and alignment process, and then the user tells the computer where the corner is located. However, the presently described methods allow the computer to, itself, determine the corner that best matches the one defined by the instructor in the initial setup.

To accomplish this, consider two observed nodes nₓ and n_{y} that have similarity sets N_{Sim}^{x} and N_{Sim}^{y}, respectively. Additionally, consider node nₖ which satisfies the similarity threshold ϵ_{Sim} for both nₓ and n_{y} such that: nₖ∈N_{Sim}^{x}∧N_{Sim}^{y}. In this case, nₓ=nₖ and n_{y}=nₖ cannot be true if nₓ≠n_{y}, which is held to be true (i.e., every observation is assumed distinct). Now, assuming nₖ is the most similar map node to both nₓ and n_{y}, a reasonable approach to validating the hypothesis above (i.e., that nₖ=nₓ or that nₖ=n_{y}) may be to always assign an observed node to its most similar map node. More precisely, the hypothesis being tested here is that a given observed node matches (i.e., is equal to) a map node. However, in this case, the node nₖ would be unavailable for assignment to either nₓ or n_{y}, depending on which is assigned first.

This suggests a “greedy” search whereby similarity scores provide a higher probability of node assignment with higher scores with some stochastic nature for random assignment to not only address the cases of tie breaking as above but provide better search coverage of the combinatorically large space. Such approaches may include simulated annealing, Monte Carlo optimization, swarm optimization, generic algorithms, etc. In considering the approaches above, what is optimized and how is the validity of node assignment confirmed? Or is at least a “best guess,” given the current observed nodes? Ultimately, the objective is to find those node assignments that minimize the difference between an observed node and its assigned map node. This may be accomplished through various objective functions, including the following: ƒ(p,p′)=Σᵢ^{N}^{_{obs}} pᵢ−pᵢ′, where ƒ(p,p′) is the objective function that takes the array of properties p={p₀, . . . , p_{N}_{_{Obs.}}} that contains all observed and derived properties pᵢ for each observed node nᵢ, along with the array of properties P′={p₀′, . . . , p_{N}_{_{Obs}}′} containing the properties pᵢ′ of the map nodes to which observed nodes are assigned, where pᵢ′ is the properties of the map node assigned to observed node nᵢ with properties pᵢ, written as ordered pairs of node assignments and respective properties. The objective function can, of course, take many forms, such as making use of normalization, averages, root-mean-square (RMS), maximum likelihood estimation formulations. The objective function selected may include any that, when minimized, find the minimal cumulative difference between P and P′, where “cumulative” can be defined as any appropriate aggregation or segmentation of the elementary differences between pᵢ and pᵢ′∀i. The task objective is then to find the set of pairs: N={(n₀, n₀′), . . . , (n_{N}_{_{Obs}}, n_{N}_{_{Obs}}′)} that minimizes the objective function ƒ. Put differently, we seek

$${N}^{*} : f ( {p}^{*} , {p}^{′ *} ) = {min}_{p , {p}^{′}} \{ f ( p , {p}^{′} ) \} ,$$

where P′={(p₀,p₀′), . . . , (p_{N}_{_{Obs}},p_{N}_{_{Obs}}′)} is the set of property pairs corresponding to the node pairs of N, and p*(p′*) are the observed (map) node properties of the optimal assignment pairs N*.

Each of the mapped and observed nodes are associated with a set of properties p. The methodology presented above makes no assumption or requirements of properties. However, the specific formulation of the objective function, f, will be influenced by the properties used. By comparing the observed and mapped nodes along with their associated properties and then minimizing the difference between them, a pair of matching nodes is identified. A pair of matching nodes may then be assumed to represent corresponding locations on the map and in the physical space.

First, in a special case where the map in question is known to be to-scale with the physical location, the rigid-body nature of the physical layout provides simplification. In such a case, it is only necessary to know the correct correspondence between one observed node and one mapped node. The remaining observed nodes can be matched merely by scaling, rotating, or translating the entire map until the remaining nodes align. This provides an exact solution even beyond the observed nodes because of rigid-body constraints. As an example, imagine the observed nodes are marked on a paper. Now, overlay the actual map with fictitious paper that allows one to scale the map up or down. By placing a pin through the mapped node and its corresponding observed node, one need only rotate about this fixed point or scale the map to find alignment. This alignment provides a complete solution for localization (e.g., all nodes are aligned simultaneously).

However, there is no guarantee that the map is to scale. The method described above can be generalized to address such cases by following affine transformations from map to physical space. The term “affine” transformation means a type of geometric transformation that preserves collinearity and the ratios of distances between points on a line. In general, we may assume that each node can be described as an affine transformation of another node. This affine transform is then a property relating a given node to all other nodes. For example, consider the two observed nodes nₐ and n_{b}, where Lₙ_{ₐ}=ALₙ_{_{B}}+B and where Lₙ_{ₐ} and Lₙ_{_{b}} are the locations of nodes nₐ and n_{b}, respectively. The matrices A and B provide the transformation which can be constrained arbitrarily (i.e., to exclude scale if scale is not a trustworthy feature in the mapped representation). Next, consider nodes n_{c}′ and n_{d}′. If nₐ=n_{c}′ is the correct correspondence, we expect the transform to be similar if n_{b}=n_{d}′ is also correct. In particular, Lₙ_{_{c}}_{′}=CLₙ_{_{d}}_{′}+D can always be written. However, if nₐ=n_{c}′ and n_{b}=n_{d}′, then A=C and B=D must also be true. Therefore, the objective function may minimize differences in transform matrices (the relevant property in this case) amongst systems of corresponding nodes. For example, in a first hypothetical case using one possible method, consider any two observed nodes and mapped nodes:

$$\begin{matrix}Observed & {L}_{{n}_{i}} = A {L}_{{n}_{j}} + B \\ Mapped & {L}_{{n}_{k}} = C {L}_{{n}_{l}} + D\end{matrix}$$

where we seek to find the corresponding pairs (nᵢ, nₖ) and (nⱼ, nᵢ) that minimize the difference in transforms:

$$\{ ( {n}_{i} , {n}_{k} ) , ( {n}_{j} , {n}_{l} ) \} : {min}_{i , j , k , l} \{ \sqrt{{( {‖ A ‖}_{F} - {‖ C ‖}_{F} )}^{2} + {( {‖ B ‖}_{F} - {‖ D ‖}_{F} )}^{2}} \}$$

where ∥A∥_{F} is the Frobenius norm of A the equation above and provides a form of RMS difference in transform matrices that can be minimized by any number of optimization methods. Certain embodiments may also optimize a difference function (e.g., not using the Frobenius norm).

For the “Observed” and “Mapped” equations above, transforms for all observed node pairs and all map node transforms can be calculated (because all map nodes are known from the map). The system of equations is underdetermined (i.e., has fewer equations than unknowns) which is why a regression-like optimization is necessary versus an analytical solution.

In a second localization method, the relative rotational positions of nodes are compared in order to identify corresponding locations between the mapped and observed space. In cases where nodes are derived from the intersection of geometries (e.g., walls), an angle of that intersection may function as a node “normal” so as to provide a rotational position for the node. For example, with reference to FIG. 2, an intersection of wall 104 with wall 106 provides node n and also an intersection angle θ between the walls. In this case, the node normal angle N\vec{ } can be defined as the bisection of the intersection angle θ (i.e., N\vec{ }=θ/2). This property can be derived for all nodes and used for optimization. In FIG. 2, a hypothetical space 108 is shown that includes multiple nodes n, each with a normal angle defined (each normal angle represented as an arrow).

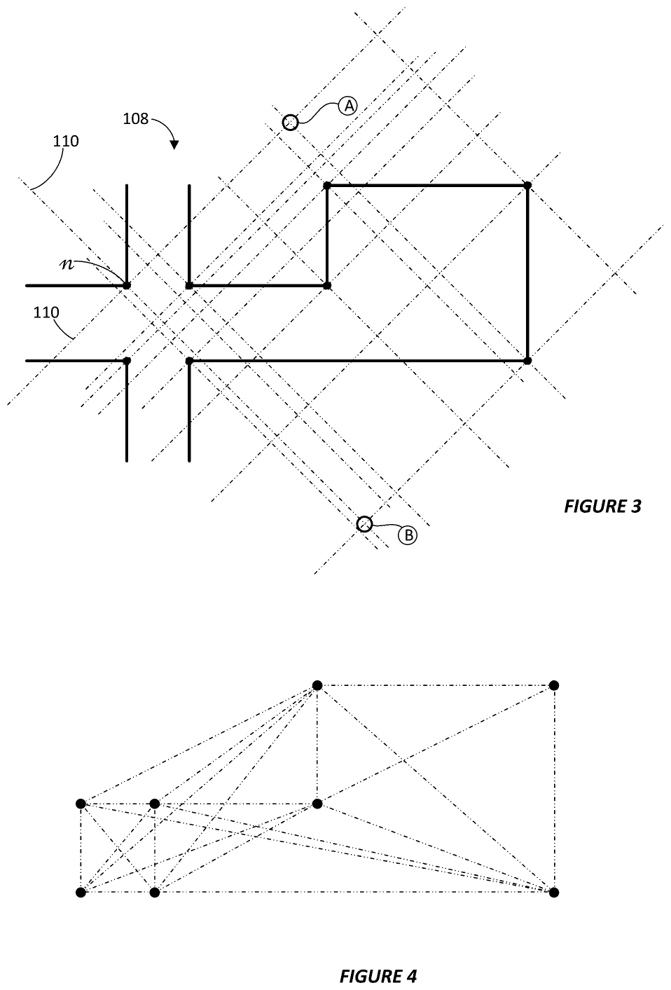

Once an orientation of the node is determined, connective properties that relate the nodes to one another and that depend only on their relative location and rotation can be defined. For example, as shown in FIG. 3, a first line 110 extending through each node at the normal angle may be defined and then a second line 112 extending through each node that is perpendicular to the first line may also be defined. These lines 110, 112 may or may not meet with lines of other nodes at an intersection (two of which are identified by circles A and B). Whether and which lines intersect with the lines of other nodes may then be considered a property associated with those nodes that permits each of the nodes to be related to one another and for them to be graphed and related to one another. This provides relationships and graph connectivity (i.e., from which graph-theoretic connectivity metrics can be derived) that does not depend on scale. In FIG. 4, a graphical representation or result of the above-described method (i.e., a graphical abstraction) is shown. Graph abstractions like that shown in FIG. 4 allow for abstraction in visualization, analysis, and storage independent of physical space representations (i.e., the graph need not be understandable to a physical map or agent).

In certain implementations of this method, the abstraction may be extended further. In such cases, properties having even broader descriptions, such as those that a human might make use of, may be considered. In such cases, such a method would allow this procedure to be extended beyond mere “maps” of nodes and, instead, to utilize a “map” of only, e.g., verbal descriptions. Generally, descriptive maps are extremely feature-poor, but are usually simpler to obtain compared to conventional maps. As an example, when requesting directions to a particular room in a building, the directions provided may include statements such as “turn left at the foyer.” In that case, without ever seeing the foyer, a person receiving those instructions would likely know when they have reached the foyer because of their familiarity with the typical characteristics of a “foyer.”

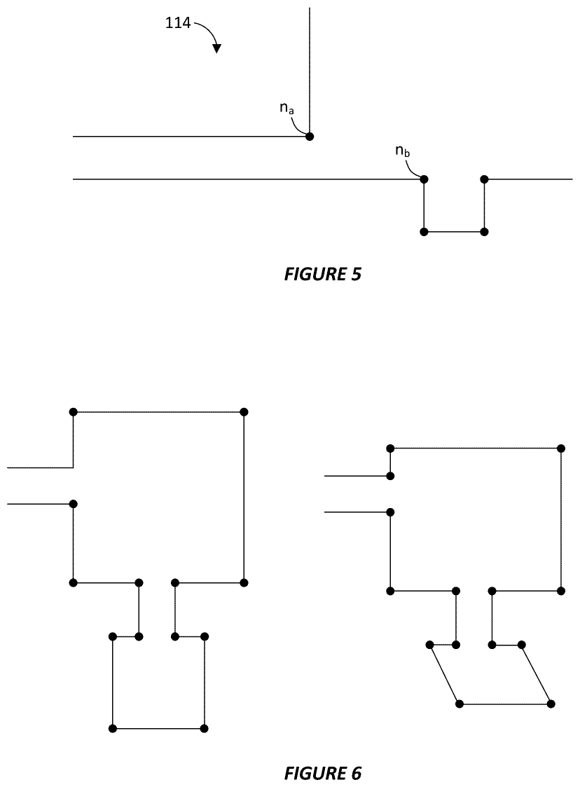

Applied to an agent observing geometric intersections that does not have accurate (e.g., to-scale or specific) physical descriptions in a map, categorical properties might be used to facilitate a similar understanding and use of similar descriptions. In FIG. 5, a map 114 provides multiple observed nodes, including nodes nₐ and n_{b}. Verbal descriptions might assist an agent in locating itself at various nodes. For example, the phrase “an intersection far from all others” might be used to locate node nₐ or “the corner of a small cluster of intersections” might be used to locate node n_{b}. These and similar broad descriptions are often how humans recognize what a specific location (e.g., a “foyer”) looks like or where it is located. In isolation, verbal descriptions often need to be extensive, even if not detailed, to be the sole property used for localization.

Providing categorical properties, such as “near 3 other nodes” or “far from other nodes,” without quantification is critical for a semantic understanding in carrying out the localization process described above. In other words, to make this process useful in recognizing what a “foyer” or what a “kitchen” is, quantitative measures such as “go 9 feet to the right and 4 feet forward” are only relevant for certain specific spaces and cannot be generalized to all spaces. Since the intent of this method is that it be applicable generally to all spaces regardless of their specific dimensions, the use of descriptions without these types of quantitative measures is important. In other cases, one may also train on semantic labeling of known spaces, such as allowing an agent to learn “what a typical foyer looks like” in terms of nodes by showing it many examples of foyers, but not the foyer in question itself.

For example, in FIG. 6, a pair of maps representing the same space is provided. In this case, the left map is drawn well (e.g., with sufficient, correct detail), whereas the right map is drawn poorly (i.e., without sufficient and/or correct detail). The map on the right might result, for example, from an agent having sensor problems or from a building that has settled over time such that the walls of the space have shifted. In this case, the relative locations of nodes across observation and map are not reliable for localization. Thus, categorical properties of nodes are critical for correctly navigating the space using these maps. A useful categorical property might be “in a cluster of 5 nodes near each other,” where the term “near” may be a classification threshold based on a pre-defined (e.g., user selected or automatically defined) distance. Of course, this method would not require an exact numerical relative distance between nodes. Another property might specify “nodes shaped like a triangle” or other similar descriptors. This is termed a “semantic” approach for describing the space because generally a human would recognize the two maps in FIG. 6 as showing the same space based on our semantic understanding and understanding of context.

The above-described procedure relates to a classification and localization approach that involves assigning categorical properties to nodes based on their classification that can then be used for localization by identifying a set of pairs N* that minimizes the differences in matched node categorical properties. Alternatively, or additionally, this could include correct classification of nodes. Classification methods, especially Bayesian methods, are well suited for and abound alongside appropriate optimization methods for categorical and descriptive properties.

Finally, the following methods are particularly useful for providing localization updates as an agent acquires new observations. In this case, the method depends on the time dependency of observations by time-ordering sequences of observations. In this method, tN_{Obs}={n₀, . . . , n_{N}_{_{Obs}}} is the set of observed nodes at time t. As such, in this case, both the number of observed nodes (i.e., N_{Obs}) and the set tN_{Obs} are time dependent. Accordingly:

tN_{Obs}(t)=tN_{Obs}

N_{Obs}=N_{Obs}(t)

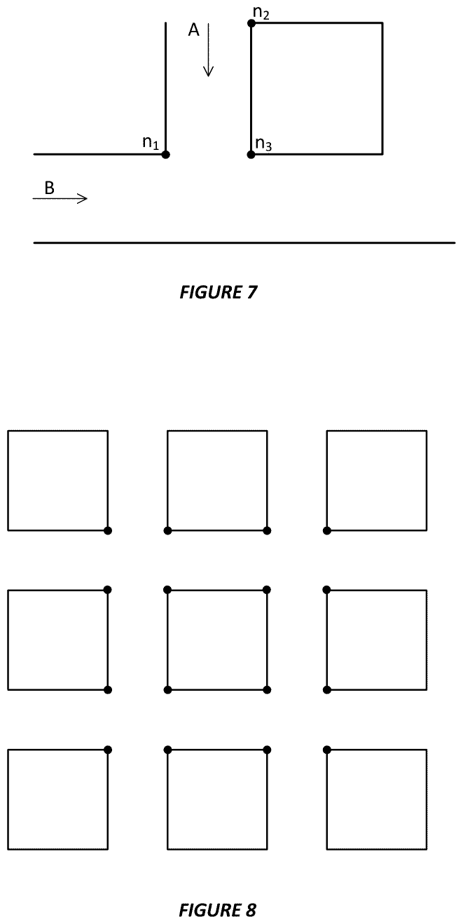

Time ordering provides a powerful constraint on finding the set of matching mapped and observed nodes because the set of possible nodes in N_{G} (i.e., the set of graphed nodes) that can correspond to the set tN_{Obs} (i.e., the set of observed nodes at time t) does not include nodes that physically cannot be observed before observing other nodes. As such, the time sequence of nodes can be used to define or recreate the path in the physical space traversed by the agent. In that case, only the subset of N_{G} lie on and could be observed along that same path. As an example, in FIG. 7, three nodes n₁, n₂, and n₃ are shown, which have properties p₁ and p₂ as n₁ and n₃ have the same properties p₁. In this case, three nodes are provided but properties of only two of the nodes need to be defined since two nodes (i.e., nodes n₁ and n₃) have the same properties p₁.

Two time-ordered approach (i.e., traversal) sequences through the space by an agent are defined and are depicted by arrows A and B. In the case of approach B, given the following:

| APPROACH | TIME t = t₀ | TIME t = t₁ |
|---|---|---|
| A | tAN_{Obs} (t = t₀) = {n₂, n₃} | tAN_{Obs} (t = t₁) = {n₂, n₃, n₁} |
| B | tBN_{Obs} (t = t₀) = {n₁, n₃} | tBN_{Obs} (t = t₁) = {n₁, n₃, n₂} |

The first two nodes observed by the agent (i.e., n₁ and n₃) cannot be matched to n₂ and, therefore, can be excluded from the search space. This is because n₂ has different properties from the observed nodes n₁ and n₃. Assuming that, on approach A, node n₃ must be observed before node n₁, when matching the map node for node n₁ can be excluded despite having the same properties p₁ as node n₃. Put differently, the physical layout prevents certain orderings of sequence observations. More concretely, since n₁ and n₃ have the same properties, they are indistinguishable from each other based on properties alone. However, they can be distinguished based on their observability in a given approach (e.g., if we know n₃ must be seen before n₁, then at t=0 (Time 1) for approach A we can entirely ignore n₁ to simplify the problem). Then, at t=1 (Time 2), we know the order and can use that as a search constraint in the optimization (even though order is not, strictly speaking, a property included in p₁, it is additional information gathered from movement of the agent). For example, on approach B, it is impossible to observe node n₂ before observing node n₃; therefore, such an approach can be deduced from the sequence of observed nodes. Thus, the plausible paths for a given sequence becomes a property of the sequence and not of a specific node. This sequence, thus, constrains the space of possible matched pairs between mapped and observed nodes.

There are certain notable caveats to the time-ordered method discussed above. First, the method assumes that agent observations are “robust.” This means that the agent passes and observes all three nodes in sequence and no nodes are “missed.” Further, the agent does not backtrack or “teleport” in order to observe a missed node. This sequence constraint relies on the physical reality that an agent cannot teleport from one area to another in observing nodes (i.e., agent cannot observe two nodes without observing all the nodes along the path between them). This is sometimes called the “kidnapping” problem, and it occurs when an agent is no longer observing and during that period of non-observation is moved, which causes the agent to appear to teleport. This kidnapping problem can result in missed observations, mis-ordered observations, and incomplete sequences of observations. Another limitation relates to the choice of node properties. Generally, the methods described above are not robust against highly symmetric maps or maps lacking any distinct features, such as in the map shown in FIG. 8. In that case, if the properties selected are such that all nodes have the same property (e.g., as a result of symmetry), then there can be no way to differentiate which observed node matches which mapped node and, therefore, no way to localize the agent. The symmetry or lack of distinctiveness of the physical layout (or map) are not, themselves, the limiting factors. Rather, it is the symmetry and lack of distinctiveness in the property space that matters. The layout shown in FIG. 8 can still have zero-shot localization with the right choice of node properties, where those properties selected break symmetry. Thus, many of these limitations may be overcome simply through property selection. Of course, in some cases, even with the full observation of all nodes, there may not be appropriate symmetry-breaking properties or sufficient distinctiveness, which limit the applicability of these zero-shot methods.

### Part 2: Generating and Presenting XR Content in Known Spaces

We turn now to scenarios where XR content is created for physical spaces that are “known” or are mapped with sufficient detail so as to enable that physical space to be precisely aligned with the XR content for a single user or for multiple users (i.e., aligning the XR content and physical space in multiple independent coordinate systems). While some current approaches to generating XR content and experiences treat physical space as “first-class” content that permits meaningful interaction between the virtual (i.e., generated) content and the physical space (e.g., bouncing a virtual ball off of a real wall), in the vast majority of cases, the physical surroundings are relegated to “second-class” status and is treated as merely passive background environment that does not interact with the generated XR content. This is similar to how many terrains or background buildings in a video game might be treated. Nevertheless, even though it is often given second-class status, the physical surroundings also still generally govern the creation of XR content. For example, XR furnishing must “fit” within the physical confines of a room. For that reason, it is often necessary to generate content that is tailored for the physical space, including by manually placing objects (e.g., game elements) within the space, which can be a laborious task. Additionally, the more closely that generated XR content corresponds to a particular physical space, the less likely it can be used for other, different physical spaces.

What is needed are more flexible and simpler methods for generating XR content that permits structured, scalable and flexible methods for integrating digital content with a wide range of physical environments while still being reasonably tailored to that physical space.

The present invention provides a method for abstracting physical space into code to allow XR content developers to develop and manipulate environments and XR experiences with principles similar to those used in software development. This approach simplifies the creation of XR experiences by providing structured, scalable, and flexible methods to integrate digital content with the physical world. This method provides an opportunity to “terraform” XR experiences in mixed reality environments. This method is generally referred to herein as “space as code” or “SAC,” which permits dynamically designing XR content by analyzing the layout, objects, and semantic meanings within a physical environment to strategically place XR elements such as items, objectives, enemies, etc. This approach allows for the creation of engaging and contextually relevant XR experiences tailored to the specific characteristics of the physical environment.

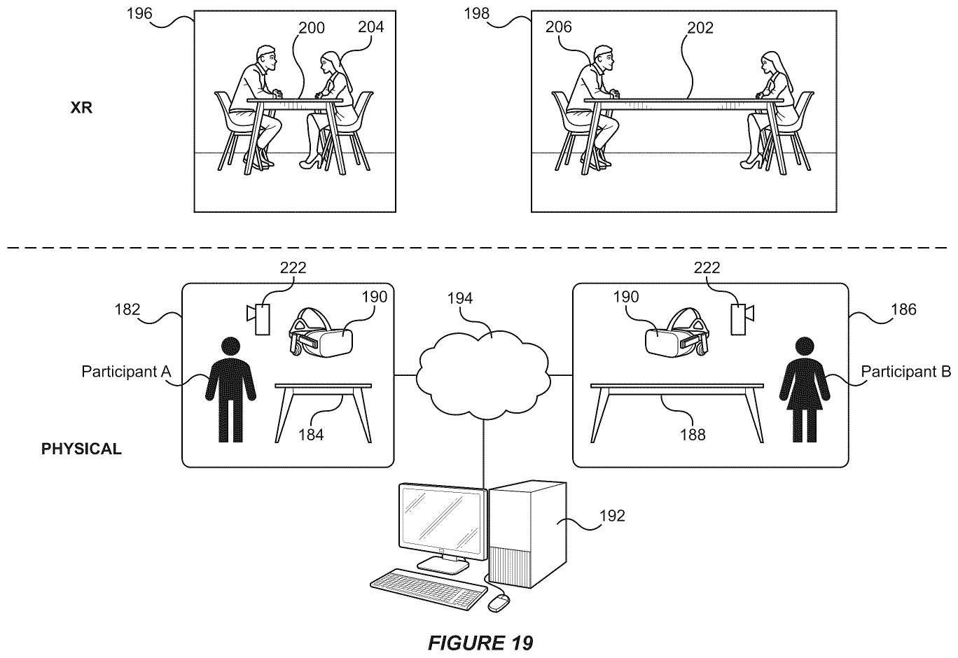

A first and critical step in the SAC process is called “spatial abstraction.” The spatial abstraction process is similar to object-oriented programing that is currently used in software development to abstract complex systems into manageable classes and objects. In a similar fashion, SAC can abstract physical spaces into digital components (called the “base geometry”). This abstraction process includes identifying and defining specific areas, objects or features within a physical space as programmable entities. For example, in certain cases, this abstraction process may be carried out using a three-dimensional scanner 222 (FIG. 19), e.g., LiDAR, which provides a raw representation of the space. Then, from that raw scan, primitive geometric features such as lines, polygons (e.g., circles, rectangles, or other generic polygons), intersections between one portion of the space and another portion of the space (e.g., the intersection of a wall with the floor), corners, vertices, volumes, objects (e.g., furniture), etc. may be determined by an XR generation system (XGS) to provide corresponding digital components.

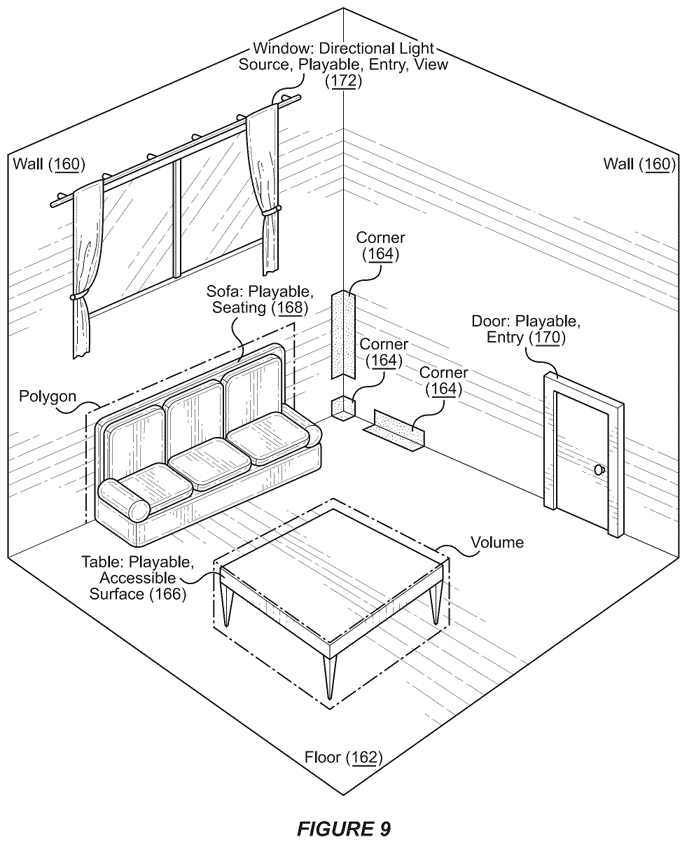

A visual representation of the results of such a spatial abstraction process is provided in FIG. 9. As shown, elements of a space 158 are identified, including walls 160, floor 162, and corners 164. Additionally, in preferred embodiments, the spatial abstraction process preferably also includes a recognition or assignment of semantics and mechanics to the elements that are identified in a space. For example, in this case, a coffee table 166 is recognized (or assigned) as having an accessible and playable surface (i.e., a user can interact with it). Next, sofa 168 is recognized as being playable seating that a user can interact with (e.g., sit on). A door 170 is recognized as being playable and also as an entry/exit into this particular room. Similarly, a window 172 is also recognized as playable and as an entry/exit into the room. However, window 172 is further recognized as providing a directional light source and also providing a view of spaces outside of the room.

The spatial elements (e.g., primitives, intersections, volumes, objects, etc.) may be considered the “atomic” or modular components or elements that can be combined in various ways to create the full user space along with basic spatial metrics for the relevant dimensions. That is, position and orientation, measured in one or more units of distance including angles and time. This ontological categorization is a helpful abstraction. For example, one might like to anchor the starting port of a spatial experience at a corner of a room. By abstracting the spatial data into the concept of Corners/Intersections, a unified method of describing, interacting with, and proscribing with the experience starting location can be achieved without the specific knowledge of the space itself. A developer could, in this simplistic example, merely provide the declaration “Start the experience in a corner” and this declaration be equally useful in any room with a corner, even if the various rooms have no other similarity. In this way, the space itself provides the code—the starting point is generated as appropriate in the corner location of the specific room in use without further need for the developer or user to provide specific information.

Next, by treating different parts of a space as modular components, developers can create reusable spatial modules. For example, a module could be a specific interaction pattern with an XR object that can be applied across different spaces or scenarios, simplifying the programming process. This is particularly useful where development in XR is currently heavily reliant on “bottom-up” approaches, where development requires the creation of specific subsystems in order to begin work or test larger systems.

Modularity and abstraction can help achieve a better “top down” approach to development. For example, with this type of approach, libraries of pre-defined spatial interactions (e.g., gestures, voice commands, proximity triggers, configuration triggers, game AI interactions, object placement, environmental reactions, etc.) can be used across multiple XR projects. This reduces the need to code common functionalities from scratch and ensures a consistent user experience. This also makes exposing hooks for user generated content creation and additions possible in a scalable fashion. Next, with SAC, developers can simulate physical spaces entirely in virtual environments, testing AR interactions and content placements without needing access to actual locations. This can dramatically speed up the development cycle and allow for extensive testing before deployment.

Next, simulating not just the space but also potential “user paths” and interactions within that space can help in designing more intuitive and engaging XR experiences. For example, developers can program different scenarios and test how well the AR content integrates with the physical space and user behavior. With SAC, where space itself has been abstracted, the concept of user paths is abstracted as well. Rather than specific paths in space, this may take the form of “User walks past X corner first, then approaches Y surface” or some other plausibly extracted form. This not only makes the simulation generically applicable across spaces but allows for easier automation of path testing because it can be performed at a higher level than specific user-agent simulation. In fact, this may be better suited to uncovering edge cases and novel user paths than traditional methods of directly simulating users in a virtual copy of the physical space.

Further, just as software development benefits from tools like Git® for version control and collaboration, XR development can use similar methodologies for managing spatial code. Versioning of spaces and the spatial logic behind them has limited meaning when dealing directly with real spatial data (e.g., LiDAR scans). However, by using the abstracted concepts of SAC, diff-able and version controllable spatial representations and the code they enable is trivial and can make use of standard systems like Git. This facilitates teamwork, tracking changes in spatial programming, and maintaining the integrity of the XR project over time.

Next, like code tracking and versioning, developers can easily share spatial code snippets, modules, and Application Programming Interfaces (APIs), thereby fostering a community of practice that accelerates the development of new XR experiences by building on existing work. Since the space itself is abstracted for application across any physical space, code re-use and sharing makes far more sense than in conventional XR development. By conceptualizing physical spaces as programmable entities, SAC not only makes top down XR programming more accessible but also opens up new possibilities for innovative and complex XR experiences that are collaboratively built. It bridges the gap between the cyber/digital realm and the physical realm, allowing for a more integrated, dynamic, and user-centric approach to XR development that is truly “cyber-physical.” Exploring the idea where the space or spatial data itself serves as the code involves a profound integration of physical environments with digital systems, where the attributes and dynamics of a physical space directly influence and dictate the behavior of digital applications, especially in AR contexts, With this paradigm shift, the physical world is not just a passive canvas for digital overlay but is, instead, an active participant in the computational process (i.e., actual spatial computing in a literal sense). Advantageously, developing standardized APIs for common spatial interactions and environmental responses can make programming XR experiences more straightforward. For instance, APIs could handle complex spatial calculations, object recognition, and user positioning, anchoring of spaces, which would permit developers to focus their efforts on creative aspects of AR experience design.

SAC enables the layering of spatial data over physical environments. This might be thought of as conceptually similar to how cascading style sheets (CSS) layers style over HTML structure. Developers can define different layers of XR content (e.g., informational, interactive, visual) that can be dynamically adjusted or replaced based on context, user preferences, or external data. Next, incorporating content management systems (CMS) that are designed to handle spatial data can allow non-developers to update and manage XR content without needing to directly modify the code, making the process of keeping XR experiences fresh and relevant much easier. While not a core logic module of the SAC system, this is an integral business module where the abstracted understanding of the spaces permits the content to be managed via space-driven logic. This also enables user-generated content creation and delivery.

Preferably, SAC also allows for direct interaction with AI systems, including modern systems like large language models (LLMs), generative AI, and the like. The generalized, abstracted and codified representation of spatial data allows the space-as-code to include code such as generative AI prompts. Specifically, this representation of spatial data can be injected as prompts to both fine-tuned and non-fine-tuned generative AI systems, thereby allowing the AI system to generate with spatial context and content. Current generative AI modals do not support direct injection of spatial data (e.g., LiDAR), but SAC can be injected in its native form (e.g., YAML implementations), which is discussed in further detail below. While future generative AI modals might directly support raw spatial data, SAC is still a preferred approach because it allows for generation that is applicable across multiple spaces without direct knowledge of those spaces. Additionally, SAC is a far more storage, memory, and training-efficient representation than very large spatial data. Especially where the context window of generative AI can be small (i.e., there is a limit to how much context can be ingested by the system for influencing generation), efficient and effective representation such as that provided by SAC is valuable as it allows for greater context on how to use the spatial data to be provide in the context window. This is effectively “space as prompt injection code.”

Next, advantageously, since the spatial data is abstracted away from the actual physical space and into higher-level representation, privacy may be preserved. For example, the application code for the XR experience simply has to know about spatial elements (e.g., surfaces, corners) but not necessarily their specific layouts or physical location to provide the experience. This is especially important for sharing spatial experiences, such as through user-generated content, where the abstraction is not only functionally important for use in multiple spaces but critical to privacy. Users can create content in their own space and share it without fear of revealing details of their physical environment. This is also a major value for sensitive locations where there may be security concerns regarding the actual spatial data.

In its essence, SAC provides a unified, privacy-preserving method of allowing the physical space to directly orchestrate the execution of XR experiences in any space. It provides a critical representation of spatial information (without concern for the actual physical arrangement) that allows for automation, scalability and sharing that currently does not exist. In many respects, SAC does for XR what infrastructure-as-code did for organizational operations around larger server deployments. It does this by breaking the current paradigm of XR experiences being either user-centric (e.g., all objects are always placed relative to a user's position) or being tightly coupled one-to-one with the physical environment. In the former case, the XR experience does not treat the physical space as a first-class citizen in the content or application. In the latter case, the one-to-one coupling prevents scalability or transferability of XR experiences from one space to another without retooling.

### Space-Driven Programming Logic

With SAC, the characteristics of physical space (e.g., dimensions, geometry, materials, ambient conditions such as light and sound levels, the presence or movement of people, etc.) become inputs or triggers for digital systems. For example, an XR application could change its behavior or content based on the time of day, as indicated by the level of natural light in the room, or by how many people are present, as detected through spatial analysis. In other cases, the relative positions/orientations of spaces (e.g., relationships between various rooms in a home) could drive additional logic or mechanics in an automated fashion. This form of space-driven logic may be particularly useful in location-based entertainment and education. Using well known, or otherwise provided (e.g., via user input or automated system) certain aspects of XR experiences like digital content placement or intensity of experience could be governed by the likely, possible, or implied user paths through a given space. For example, if a museum has an XR experience and there is a constraint on the total number of people permitted in a given space at any given time, space-driven logic in this system could alter the experience implementation automatically based not only on the user but from museum to museum, depending on both the layout of exhibits and past data (where available). In this and other cases, since SAC abstracts away the specifics and one-to-one nature of XR content development, this type of automated logic is a key component of SAC to ensure experiences are implemented as desired regardless of location.

In certain cases, the concept of space-driven logic can be extended further through the concept of “physical configuration as code.” The layout or arrangement of objects and elements within a space could act as “code” that programs the behavior of an AR experience. For example, moving a piece of furniture or changing the orientation of a room could trigger different digital interactions or content to appear in AR, much like changing a line of code alters the output of a software program. This makes the physical arrangement of spaces a direct method of programming digital interactions. In preferred embodiments, even everyday actions like opening a window, adjusting a light, or rearranging objects could directly manipulate XR experiences in real time. For example, opening a window could automatically lessen virtual content to encourage appreciation of the outside, or trigger XR experiences that are visible from the window. In another example, moving an armchair to a given position could initialize a virtual game of chess and might log a user into a multiplayer session, while moving the armchair to a different location might initialize an XR entertainment center for moving watching. This concept can also be used for more directed marketing or content placement, such as social medial posts or advertisements. In a similar vein, running the same program in a different location (e.g., layout) will result in a different experience. This is why we term it “space as code.”

With spatial data as code, XR experiences become inherently contextual and adaptive, automatically adjusting to the specifics of the user as well as the environment. Further, in certain cases, using cognitive load, performance, biometric, interaction, session, or any other user data or external data (e.g., demographics), the physical space can be extended to include the meta representation of that space with its users within it and adjust the XR content as a result. Because this is included as a module in the SAC system, it can be deployed and run in an automated fashion with or without user governance.

### SAC Syntax & Runtime Interpreter

Just as programming languages have syntax, SAC has a syntax for assembling the abstracted spatial data. In other words, SAC has a set of rules that defines the combinations of symbols considered correctly structured code. Spaces have an “environmental syntax,” which defines how different spatial configurations, environmental variables, and user interactions are interpreted by XR systems to trigger specific outcomes. For instance, a room setup may be represented (i.e., abstracted as) a collection of objects (detailing the object types, e.g., a couch, their orientations, positions and dimensions), surfaces or polygons (detailing the shapes, relative positions, proximities, orientations or dimension), intersections (such as where walls join, detailing location or orientation), or even basic parameters (e.g., overall room size or available floor space). Such a collection may be represented in various ways, such as YAML or JSON, via verbal description, drawing or other appropriate representation (we term this an “encoding”).

To obtain the data in the appropriate syntax, SAC has an extraction pipeline that takes the physical spatial data (e.g., LiDAR data) and converts into the abstracted representation. The pipeline captures and analyzes real-time and non-real-time data about the physical environment, including spatial geometry, object recognition, and environmental conditions (e.g., light, sound, temperature). Importantly, this extraction can be implemented entirely on-device, or locally, such that privacy is secured. The final abstracted result need not have any direct knowledge of the actual physical space in detail, beyond the abstracted concepts. In fact, even things like positions and orientations can be made to be entirely relative-perhaps one element is chosen as the “origin element” for all others. This way, no physically identifiable data is directly present in the SAC. In some embodiments, depending on how the abstraction is selected or produced, it may not be necessary to have any information about placement or dimensions at all.

Next, to make use of the SAC in physical locations, an interpreter (e.g., a runtime interpreter or an interpreter that runs at times other than runtime) is used. This interpreter is functionally what allows the space to act as code. Fundamentally, the runtime interpreter is “where the abstraction must become the reality.” The user ultimately lives in a real space with specific layouts and dimensions, etc. The abstracted SAC representation is converted into concrete realities and this is accomplished via the runtime interpreter. The runtime interpreter may exist or operate at a few levels. First, it translates the abstracted objects detailed by SAC to their corresponding physical equivalent in the actual space (which can be done locally to preserve privacy). For example, the interpreter may receive from SAC “an east-facing couch” or “a corner in a room of minimum size X.” The interpreter then needs to identify where (and, in some cases, if) an east-facing couch or if a particular type of intersection (e.g., corner) is in the actual physical environment. The same could be done for more “atomic” elements such as “a polygon with orientation Y.” So, the more abstract the element is, the more broadly applicable it is and vice versa. That is, the interpreter reads the spatial abstraction and converts it back into concrete spatial locations/objects in the actual environment. The specifics of the interpreter's processing will vary based on how abstracted the input is. This is a possible step in the interpreter's process, and would be sufficient for, as an example, a developer's coding of “Place this advertisement 3 feet away from a couch facing east but place this other advertisement facing west.” In certain cases, the interpreter could include additional and more complex information as well. For example, the interpreter could add game mechanics, such as where and when triggers happen or how content should be adapted. However, again, it is translating the abstracted, generic representation of SAC into a concrete representation that is actually executed in the real space. We also note the interpreter need not operate at runtime in all manifestations. Interpretation of the space from abstract to concrete could be done in a pre-processing, loading, compilation or other step that occurs prior to the runtime of the XR content.

This means it must be able to map the Spatial Programming Interfaces (SPIs) and the abstract spatial data back to the physical world (including preferably performing this step entirely locally for security and privacy reasons). That is, the interpreter uses the abstracted spatial data along with the business logic of the XR experience application to map objects, events, interactions and other experience content and components back to the user's actual physical space—making it a real XR experience. It also enables execution of interactions and serves as the interface to (or even as) the underlying XR engine.

SPIs allow developers to specify how various spatial parameters, spatial elements and actions map to digital outcomes. These interfaces are core to the low-level implementation of XR experiences that sit on top of the abstracted spatial data that is core to the technology. So, the interpreter is also translating from abstraction to concrete input that can be used by these SPIs. The example below illustrates an SPI implementation. In this simple example, environmental conditions such as light levels, temperature, and the presence of objects or people serve as triggers for XR events. In this example, when a visitor approaches a painting and the ambient light is sufficient, an XR overlay appears with default brightness levels and provides insights into the artwork's history, artist, and interpretation. The appearance of the XR content and the insights provided here are examples of game mechanic function. On the other hand, if the light level is low, the XR system adjusts the overlay's brightness and offers to illuminate the painting with a virtual spotlight. This is an example of a baseline physical function. In this case, the SPI consumes the input of the user's position and the ambient light level (e.g., as might be measured in lux), and outputs the appropriate XR content (or changes to XR content). In this case, the SPI is an interaction mechanic that is triggered based on spatial inputs. This approach allows developers to craft interactions that are not only immersive but also responsive to the nuances of the physical environment, enhancing the user's engagement with the digital content.

### Use of Artificial Intelligence in SAC

SAC also allows for direct interaction with artificial intelligence (AI) systems that is currently not possible with pure (i.e., raw) spatial data. This includes modern AI systems like Large Language Models (LLMs), generative AI and the like. The generalized, abstracted and codified representation of spatial data allows SAC to include code (or function, itself, as a prompt to AI such as LLMs) such as generative AI prompts. Specifically, this representation of spatial data can be injected as prompts to both fine-tuned and non-fine-tuned generative AI systems, allowing the AI system to generate with spatial context and content. Current generative AI modals do not support direct injection of spatial data (e.g., LiDAR), but SAC can be injected in its native form (e.g., YAML implementations as shown above). While future generative AI models (or the various modals they accept) might directly support raw spatial data, SAC is still a preferred approach because it allows for generation that is applicable across multiple spaces without direct knowledge of those spaces. Additionally, SAC is a far more storage, memory and training-efficient representation than very large spatial data. Especially where the context window of generative AI can be small (i.e., there is a limit to how much context can be ingested by the system for influencing generation, such as a limit on number of token data as one example), efficient and effective representation such as that provided by SAC is valuable as it allows for greater context on the spatial data and how to use it to be provided in the context window. This is effectively “space-as-prompt-injection-code.”

By using spatial data in this way, it is possible to make direct use of modern AI technologies to automatically and intelligently generate XR content-either ahead of time or on the fly at runtime. While generative AI cannot currently interact with the actual spatial data or the environment, it can help devise a strategy for placing game elements in a way that enhances gameplay, challenge, and user engagement based on the descriptions provided. For example, in the case of an XR active shooter training for police, a prompt may be provided to an LLM that includes abstracted spatial data for a school building. The prompt might specify that training experience should replicate a real-world event, such as an actual school shooting (e.g., Columbine), with as much fidelity as possible but in this particular school's space (which is not the same school as the actual event that the XR experienced is based on). The prompt may specify details about the actual event, including the number and behavior of adversaries. An LLM might then provide verbal details of where and what to place in the XR content, where positioning is in the context of the abstract spatial data. It could even provide information on adversary behavior, or small changes to what happened in the real event not just to match the physical space but to highlight training objects that are perhaps indicated in the prompt. This output from the LLM can be parsed and input for a content generation/translation engine to generate it in the XR experience. For example, in certain cases, the XGS is JSON-based that can be natively output by an LLM. In other implementations, by connecting APIs, LLMs (even in current form) are able to directly act with other systems such as directly implementing the output (e.g., placement of content or behavior of adversaries) in the XGS.

In other cases, XR content may be created using AI after ingesting or based on real-world events (e.g., trends in crime or incidents of concern taken from monitoring news or social media data). In such cases, aggregations of data and general concepts of what police might face can be provided as a prompt to an LLM, along with the SAC abstracted spatial data and the generative AI recommend and generate an appropriate set of training exercises in the actual space (to be interpreted directly or via a content translation engine). The core of this capability is spatially aware generative AI for automatic creation of XR experiences and content, which would not be possible without SAC.

### Additional Advantages of SAC

SAC also allows for the use of other machine learning, data analytics and data science methods beyond generative AI. The abstracted and well-structured (or semi-structured or even unstructured) nature of SAC spatial data makes it amenable to statistical, mathematical, semantic, quantitative, qualitative and other types of data analysis. It is also joinable with other datasets in ways not possible with traditional spatial data, opening opportunities for broader types of analysis. All of these analyses or their results can, of course, be re-injected as forms of prompts to generative AI. For example, in certain cases, the abstracted spatial data may be used to create a level layout for an XR game that is engaging and that utilizes the environment's natural and artificial elements to enhance the gameplay experience via AI like an LLM. Adjustments can be made based on user feedback, game balance, and the desired difficulty level. Additional factors may also be considered, including user movement speed, enemy types, and interaction possibilities with the environment.

### Spatial Abstraction Through Layered Encodings

In certain cases, the spatial abstraction process can use, and a space may be represented by, various encodings. These encodings permit the combination of descriptions of the essence of a space with the functionalized nature of experiences that interact with that space. These encodings could take any form, such as YAML, binary, numerical sequences, images, verbal or text descriptions or even organic molecules (e.g., bacteria)—any encoding that can store, retain, and allow the retrieval of information (e.g., information related to the digital components or the baseline physical function). For example, in some cases, the effect may be achieved using structure or semi-structured, machine-readable formats such as a YAML or JSON schema with appropriate fields and layers, or even custom-designed language runes.

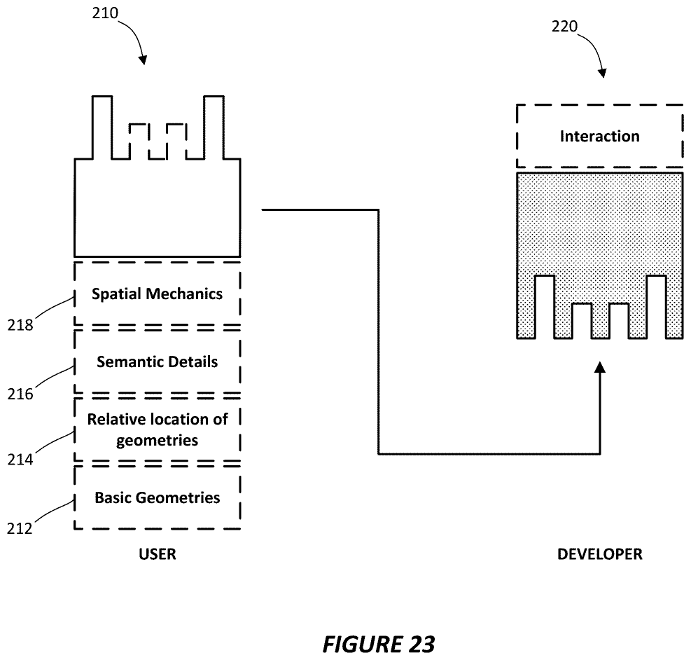

In one manifestation depicted in FIG. 23, an example of one of these encodings 210 is shown and, as shown, may have layers containing different aspects of the abstraction. The various layers described below are all optional and the precise structure of any particular encoding will depend on its application or use. For example, in the illustrated case, a base layer 212 may comprise the abstracted geometry of the space. Preferably, this layer captures the planes, surfaces, polygons, intersections, lines, and points that describe the space. Base layers 212 can be thought of as the logograms of the key spatial morpheme of a SAC language. The base layers 212 are expected to remain the same for a given space as it is a direct translation of the space. The translation can be performed by any means of gathering the geometry of the space. For example, one might probe the space with depth sensors whose raw data can then be analyzed to identify geometries. The relative placement of base layers 212 within an encoding 210 (e.g., if encodings are a sequence of binary data, the relative placement of base layers within the sequence) can also provide information of relative geometry placement, in some manifestations. Though, in the interest of privacy, this aspect or implementation choice may be ignored. One should ensure that the relative positions are intended to encode such information before assuming it is present.

Next, dimensional layers 214 are applied. These dimensional layers 214 explicitly encode spatial relationships (e.g., relative position) of the geometrics represented in the base layers 212 described above. This can be achieved many ways within a given encoding 210, including placement in the encoding. While base layer placement may optionally represent some small amount of spatial relationship, dimensional layers 214 can provide more robust details and tiers of relationships, including conditional or nested relationships. Next, semantic layers 216 may be attached to the base layers 212 or dimensional layers 214 to provide semantic information. For example, semantic layers 216 attached to one or more base layers 212 can be used to indicate that a set of geometries form a table, a table leg, another part of the table, etc. Next, mechanic layers 218 and, optionally, their placement (or other encoding attribute) preferably encode spatial mechanic information. This is information that concerns how the space itself behaves. This behavior may be changed or restricted by the developer or user and the type of behavior they include or will allow for a given space. The information encoded by mechanic layers 218 may include information on materials and how they behave or even information as simple as, for example, indicating that a door is or is not openable. This stage of spatial abstraction begins to support developer-side decisions (e.g., what mechanics to allow) but is still driven by the space and privacy is preferably dictated by the user (e.g., a user may enforce a door is not openable to preserve their preferred style of gameplay or may restrict what information is available to developers). Finally, interaction layers 220 are the last and most specific part of the encoding 210. Interaction layers 220 provide the specific, allowable game (or other experience) mechanics and/or interactions. Put differently, interaction layers 220 are the abstracted representation of how virtual content interacts with the physical space, the user, or other virtual content (i.e., including itself). Interaction layers 220 may define or form the application itself (e.g., game mechanics) or at least its category (e.g., a first-person shooter game) even without specific content. However, specific content may also be included.

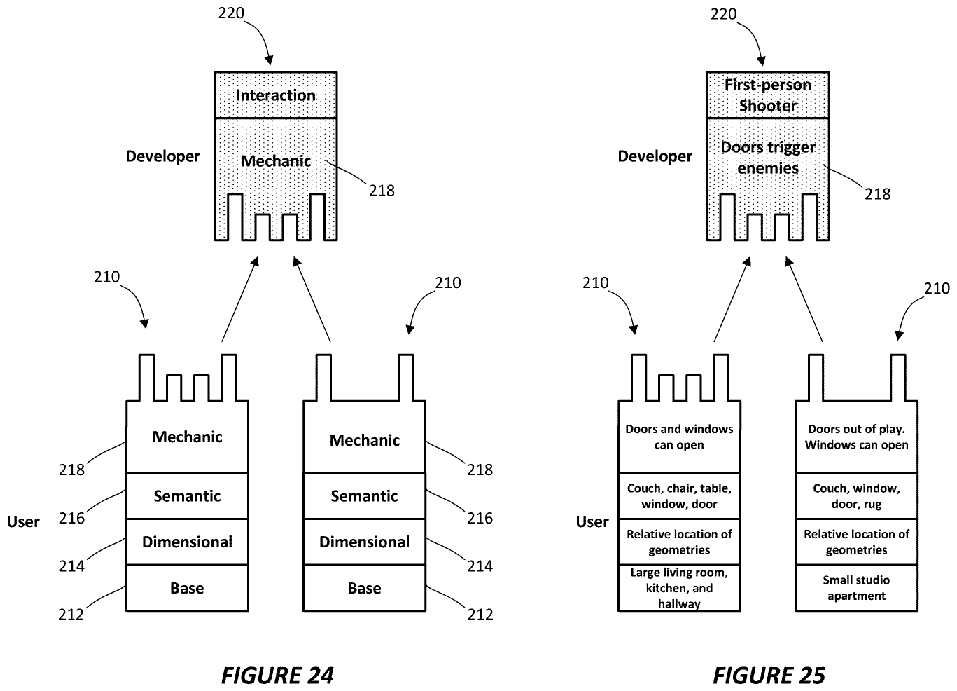

In general, the encodings 210 formed using the components described above (or with other layers, as may be used) may be thought of as “plugs” of varying complexity that are controlled by the user. The interaction layers 220, in this example, and their arrangement may be thought of as the “receptacle” that receives appropriate plugs and that are preferably designed by application developers. The interaction layers 220 preferably accept mechanic layers 218 based on its design. However, mechanic layers 218 may be skipped or not provided when not required by the XR content. The XR experience is, thus, powered (i.e., generated and made functional) by plugging the “plug” into a corresponding “receptacle.” Thus, the same “plug” (i.e., rune or encoding) may be used in conjunction with many different “receptacles” (i.e., content, game, experience, or application) and a receptacle may accept many, or preferably any, plug. The exact division of “plug” vs. “receptacle” may differ in other implementations, or for different layers, but the concept is, in part, a division of space from content or experience, allowing the scalable reuse of XR content and systems across many different spaces. For example, as shown in FIG. 24, the mechanic layer concept (i.e., mechanic layer 218) may exist on both the “plug” and “receptacle” side, where input from both users and developers determine what is possible within a space, or the mechanic layer may be entirely controlled by the developer or user (e.g., the user allows anything the developer may choose to encode). In such cases, the mechanic layer of the user receptacle may match the mechanic layer of the develop plug identically (see encoding 210A) or in some modified form (see encoding 210B) where only a portion (or even none) of the mechanic layer of the plug matches the mechanic layer of the receptacle. Likewise, the mechanic layer of the developer plug may match the mechanic layer of the user receptacle identically or in some modified form. As an example, the user may expose (i.e., make available) all of their data to the developer. The developer plug might use all of that data when the plug and receptacle are a match or the developer may only use a portion of the data if the plus and receptacle only partially match.

Thus, the encodings 210A, 210B may each be used with the same interaction layer 220 (i.e., “receptacle”) but each provides substantially different functionality and experience. For example, while encoding 210A matches the mechanic layer and the developer plug (including interaction layer 220), encoding 210B does not allow all mechanics that are allowed by the developer, which is illustrated by the missing/optional center prongs of the “plug.” Finally, while the “receptacles” (i.e., the experience, the game, or the application) need not have direct access to a real physical space, or be created with a particular space in mind, it uses the abstracted concept to the define the application, including methods of defining the application in spatially relevant ways, which can then be used by the plug in a real physical space via a runtime interpreter. Similarly, even when the “receptacles” are created in a specific space, or with a specific space in mind, SAC allows those developed experiences (or games or applications, etc.) to be used or applied in entirely different spaces.

The encodings 210A and 210B and interaction layer 220 of FIG. 24 are shown in FIG. 25 with further information. In FIG. 25, a developer might create the XR or game content using SAC representations of various concepts in SAC language (e.g., “Enemies enter through doors and windows. Place ammo under a table within a certain distance of a door.”). In the two examples given in FIG. 25 (i.e., a first-person shooter game), the same “receptacle” is used for two very different plugs. Encoding 210A provides a large living room, kitchen and hallway having a certain arrangement (i.e., geometry) that includes a couch, chair, table, window, and door, and where the doors and windows are permitted to open. On the other hand, encoding 210B provides a small studio apartment having a different arrangement (i.e., geometry) that includes a couch, window, door, and rug, and where the doors are not permitted to open but the windows are permitted to open.

### Network Application of SAC

Certain embodiments of the present invention leverage Space as Code to enable dynamic (i.e., continuously and/or in real time) network and communications management, including network segmentation, in XR applications. Space as Code allows developers to define security and stream policies programmatically, as well as other aspects, such as signal APIs, streaming or bandwidth infrastructure, Quality of Signal/Service (QOS). These efforts, individually and collectively, may, thus, be used to modify the delivery or communication of data including XR content, including the delivery and communication of that content to users, based on the space where it is received (e.g., consumed or interacted with) by the user(s). For example, if unusual behavior is detected from a specific XR headset, that part of the network or that headset may be isolated or its communications may be modified (e.g., slowed). These and other similar steps can be enforced by manually or automatically, including by being AI-driven or other algorithm mechanisms, or manual mechanisms. In particular, by abstracting out the details of the space itself, via SAC, programmatic definitions are allowed for any space that matches the abstraction. The rules defined with the SAC abstractions may include, without limitation, isolating network zones, controlling data access, and managing communication channels. This could be combined with, for example, a system to continuously monitor the XR environment and user interactions, adjusting network segments, security, bandwidth, bitrate or even QoS dynamically to isolate threats, secure sensitive communications or prioritize bandwidth and bitrate where it is needed most (e.g., for remote rendering of XR applications).

There are several meaningful reasons to apply SAC to networking and communications for XR experiences. The first, as already noted, is security. By deploying in a manner that abstracts the physical space into an appropriate SAC abstraction, anomalies can be detected, including by spatial location, and potential threats identified through spatially correlated traffic and interactions (i.e., traffic and interactions with information about the spatial location where they occur). Furthermore, the spatial information available in this approach allows for changes, including automatic changes, to the networking (e.g., network segmentations or reconfigurations) that can be done in spatially relevant ways (e.g., isolated sections of the network in certain parts of a building) to contain or otherwise respond to threats, secure communications, or provide other security benefits.

While variable bitrate is commonly used in video or audio encoding, the method described here allows for spatial variation of bitrate (or other metrics of relevance to networking, data transmission, or communications such as QoS). In a second, non-limiting, example, another application may be gaming (or another experience not necessarily for entertainment, such as training). In this example, the location of users and/or the content they are experiencing may require more or less bandwidth within a given XR experience. By combining communication policies with SAC, communication aspects can be optimized, such as tuning QoS for relevant locations to optimize bandwidth. For example, in a multiplayer experience there may be more users on the north entrance of a building than the south, and thus bandwidth may be prioritized to the northern parts of the building with specific accommodation to the layout of the building (e.g., inferred likely paths of users, materials used in the building that may restrict wireless service, etc.). This of course can be dynamically updated as users move or interact based on policies informed by SAC. Similarly, even if the user count is not at issue, a user may experience more network-intensive content in some areas of a building (e.g., the user may encounter streaming video ads in one part of a building, vs. static image ads in another). In this case, even for a single player, SAC-informed communication policies may prioritize bandwidth to certain parts of the building, based on both the content of the experience and other spatial aspects such as spatial geometries and building materials that may influence communications (particularly wireless communications). We note that by being SAC informed, the above-described examples may make use of spatial abstractions as well as spatial and interaction mechanics and semantic information as may or may not be defined via various layers as described previously.

This approach and use of SAC allows it (i.e., this network management approach) to scale with the complexity and size of the XR environment, both physical and environmental. Policies can be updated and refined as new threats emerge or as the XR application evolves, or network and communication need for applications change.

Communicating Information within Environments

Next, methods of communicating information or teaching include didactic learning (e.g., teacher-led expositions of information that are typically provided in a lecture format), pedantic learning (e.g., showing information), pedagogical learning (e.g., hands-on learning), dialectic learning (e.g., discussion or dialog-based learning), Socratic learning, clinical learning, and other forms of learning. Each form has varying uses and appropriate applications and may be used together in various combinations. However, current methods of conveying information within “contextual” environments are often limited by a number of factors. As used, the term “contextual” means communicating information about a physical or virtual (i.e., XR) location within a relevant physical location, where the user is within that location (either physically or virtually).

In certain cases, content is not necessarily integrated into the environment. This is the most common and, generally, the most affordable method for relaying information. As an example, a new employee might receive an orientation to their workplace that consists exclusively of a slide presentation or video-based walkthrough of an office. This approach is appealing because it provides critical information (e.g., policies and procedures). This information may be independent of the environment or learning the information requires more than simply “experiential exposure,” where learning is not sufficiently achieved simply by being a student, being present in or interacting with a particular environment. For example, when learning to operate a fire engine pump panel, it is generally insufficient to simply see the panel; instead, one must be taught core knowledge of operation, including both theory and operation. Frequently, this type of information is best delivered didactically. Didactic information is often considered the “hardest” information to learn and is, therefore, often delivered in a lecture-type format with a teacher actually present (e.g., either physically or virtually) or the information being guided in some automated fashion such as computer-directed learning.

Next, in other cases, content is integrated into the environment and is delivered in real time. This might be considered the “docent” approach, where an instructor provides guided education (e.g., a tour guide in a museum or an employee providing a guided walkthrough of a facility). Apprenticeships, one-on-one learning, on-the-job, and other similar training frequently makes use of this approach. However, while this approach provides a means for didactic and pedagogical information transfer as well as environmental context and interaction, it is not easily scalable. Group sizes for providing such information are typically limited when compared to pure lectures (e.g., consider the difference in class size between a biology lecture and a biology lab). The need for an instructor also increases the overall cost and limits availability of this form of education as well. This problem is further exacerbated if the information must be presented to groups of students over multiple time periods (e.g., during multiple working shifts), which would require an instructor to be present during each relevant time period or for students, employees, etc. to be available outside of their normal class or work times.

Finally, in a third group of cases, content is integrated into the environment but is not necessarily delivered in real time (e.g., is pre-recorded and can be played back on demand). This approach has the benefits of the second approach discussed above but is more scalable because it does not require the presence of a human facilitator or instructor. In this case, all informational content, including interactive and simulation content, didactic and pedagogic content, and the like is created and delivered with environmental integration. As used herein, the term “environmental integration” means any form of contextual or other placement of information in an environment, use of the environment as part of the content (including participant or other content's interactions with the environment), referencing of the environment, delivery of information within the environment, or other forms of integration.

Conventionally, this final approach to learning is difficult and costly and can be burdensome to participate in or to facilitate for other reasons as well. For example, suppose a company provides a digital application that is tied to QR codes. As a participant approaches and scans a QR code placed in a particular location within a facility, they receive information relevant to that location. Another example of this type of education is audio-guided tours of historical sites and museums where participants might provide a simple audio system with a code found at a location to hear an audio interpretation of an exhibit or location. In many of these cases, the pre-recorded nature of the content raises several issues. For example, due to the cost and efforts required, information is only infrequently updated. Next, there is often a significant hurdle in implementing and updating existing information delivery methods to use this format. Next, many current methods are focused exclusively on providing didactic, pedagogical or interactive education, not a combination of these methods. Finally, current methods have limited, if any, ability to be informed by interactions or performance of participants. While the content might be interactive, it is frequently not reactive or proactive to the participant. An advantage of the docent approach discussed above is that the instructor, guide, etc. is able to provide feedback to participants or adapt their teaching style, whereas such feedback is not readily available here.

These issues are pronounced when such teaching methods are applied to “spatial” content that uses the surrounding virtual or physical environment to convey information. For example, consider fire extinguisher training within a building. To satisfy certain compliance requirements (e.g., OSHA), a participant might be required to receive certain lecture-based information on the use of a fire extinguisher. However, this information benefits from being delivered in the environment where the fire extinguisher would be used, such as next to an actual fire extinguisher for exposition of where they are likely located. Further, advanced training may also include a simulation or practice using the fire extinguisher in the actual space. In another example, consider training a security officer on performing a walk down and security threat identification. In such a case, environmentally integrated information can allow the participant to visualize the areas of a building that are points of risk, which can improve their response during an emergency. Each of these scenarios benefit from content that is not only simply integrated into the environment but that is also tightly coupled to the environment contextually and interactively.

The methods for communicating information discussed below seek to address certain shortcomings of the third group of cases (i.e., where content is integrated into the environment but is not necessarily delivered in real time) in order to provide environmentally integrated content in a scalable fashion. With this approach, a participant can access information when and where they desire, including receiving information within the environment (e.g., didactic or pedagogical lectures). This provides logistical benefits and cost benefits over conventional methods as well as benefits of improved information comprehension, retention, etc.

These methods utilize the concept of “content volumes” or “CVs,” which are three-dimensional volumes of space in which information is made available to participants. The content provided by CVs might include one or more of interactive content, pedagogical content, didactic content, or any other form of educational content that is relayed to a participant via audio, visual, or haptic means. Importantly, CVs are considered a type of content asset that can be placed within an environment. The CV may be placed in a specific location in either physical or virtual space, placed relative to other objects (e.g., always placed near a certain type of object in an environment or at a certain distance from an object) or placed based on performance or achievement of certain activities (e.g., present information after the user has walked X meters within a building, or Y minutes after receiving prior information).

The CV can be populated with additional content, such as props, audio, visual presentations, and the like or combinations thereof that assist in conveying information. In other cases, the CV makes use of objects and content already located in the space, such as by placing a description or prop near an environmental object that provides a description of that object.

As an example, returning to the fire extinguisher example, a CV might be placed near an actual fire extinguisher. This particular CV might contain a presentation covering the OSHA-required training lecture as well as a digital prop of a fire extinguisher that the user can interact with. In certain cases, props may also be physical and may be integrated within the system in such a way that they provide telemetry on the user or is interactive in ways that are measurable and recordable by the system. Labels (e.g., virtual labels) describing the various parts of the real-life fire extinguisher might also be virtually included and appropriately placed relative to the physical object.

Interactions within the CV can be governed by any mechanic, including mechanics specifically designed around information delivery. For example, the participant may not be able to move past presentation slides until a certain amount of time has passed or an action has been completed (e.g., interacting with the props, completing an assessment or simulation—this leads to greater variability in acceptance criteria for training and education). The CVs themselves can also be interactive, such as by appearing as a participant approach and then disappearing as they move away, or only appearing if the participant has already completed prior CVs or other actions in a pre-defined sequence.

Placement of the CVs can be performed through various methods to define their location in the environment, including defining methods, rules, or sequences (e.g., algorithms) for their location (e.g., relative to other objects, as a result of certain behaviors or objectives, or relative to participants). In the case of virtual environments, methods for this placement are digital. On the other hand, in the case of physical or mixed virtual-physical environments, placement of CVs preferably occurs either via a digital twin (or partial twin, such as a local mapping) of the environment or through the use of “markers” in the physical world. These markers may be computer vision-based objects (e.g., spatial anchors based on visual features, QR codes, depth sensing, or other similar markers), geometric markers (e.g., by using intersections of physical features), geo-spatial markers (e.g., GPS coordinates), signal-based markers (e.g., RF or Bluetooth beacons, Wi-Fi positioning), or user-provided markers (e.g., inputting a location identifier manually).

Next, it is still necessary to populate or to place these CVs with the information one seeks to convey. As used here, “place” or “placement” of the CV may include both a spatial placement as well as a temporal positioning. As noted previously, current approaches of providing updated content (e.g., updating slides or presentations) are manual and, therefore, require high effort and cost. To simplify this process, including authoring new content and integrating existing content, a pipeline for automatically integrating presentations and lectures within an environment is provided in the present method. This pipeline can be, but is not limited to, within a CV. In general, the pipeline takes a presentation that is created in another system (which may be provided as a file, database record, or other digital embodiment) as an input. The presentation is then deconstructed to extract certain details, including the following types of details: (1) presentation length, including time (e.g., in a recorded presentation), number of slides or another similar metric that is appropriate for gauging length and that is appropriate for the specific type of presentation; (2) text content, including information about text size, font, color, or other typesetting characteristics, and the placement of text within the presentation; (3) graphics, 3D objects, models or assets, images or pictures, image size, raw graphic data (e.g., JPG, FBX, or other representation of the item that can be processed and viewed by a system), and placement within the presentation; (4) audio, including relevant data on bit rate, playback speed, timing, raw data, and its placement within the presentation; (5) interactive elements, such as buttons, haptic feedback, forms, quizzes, games, interactive graphics or other parts of the presentation that are intended for interaction by a participant in the presentation, including size, placement, raw data, interaction mechanics, timing and outcomes of such elements.

This deconstruction is then stored (e.g., in a memory) in a structured or semi-structured format that can be interpreted by appropriate information conveyance systems to reconstruct the presentation as environmentally integrated information (e.g., within a CV). More particularly, the deconstructed data is preferably passed to an interpreter that is responsible for reconstructing these elements. Given the increased flexibility provided through this deconstruction-reconstruction method, traditional methods for interpreting and integrating the data may be out of place here. Therefore, it may be appropriate for the interpreter to alter its presentation of these elements in a manner that is better suited for use according to these methods. For example, such alteration might include different or specific placement of certain presentation elements to fit those elements in a particular virtual or physical space, moving or removing elements to foster better integration with the environment (e.g., moving graphical content to a contextually relevant location in the environment), etc.

In one specific example of the above-described method, one or more slide presentations may be emailed by a user to an email address that is dedicated for use by an appropriate information conveyance system that implements these methods. The presentation slides, which consist of text and images, are deconstructed into one or more JavaScript Objection Notation (JSON) objects that are then passed to an interpreter and made available as assets within an appropriate authoring system. A user may then place a CV in a virtual environment and then, via a user interface, select those presentations or portions of presentations that they want to utilize in that placed CV. The interpreter, upon viewing or otherwise interacting with the CV, reconstructs the presentation within the CV, e.g., presenting the text and graphics of a slide on a wall of a cube-styled CV. The participant might interact with the content (e.g., advance or rewind slides) through an appropriate user interface, event-driven action of the user, spatial awareness, etc. Other forms of implementation of this method are, of course, possible, including for various types of presentations. This could include, for example, non-linear and non-slide-based presentations or even 3D presentations (e.g., Prezi® or JigSpace® presentations or the like). Any of these might also involve interactive elements, such as quizzes, assessments, etc.

Next, the present methods may also utilize Simulation Events or “SEs,” which consist of information content that takes place in the environment in the form of a simulation. As used here, a “simulation” may include a drill, practicum, exercise, interaction, task, rehearsal, or other activity in which information is consumed through practice or “doing.” In contrast to CVs, which may be intended (though not exclusively) for didactic and pedagogical purposes, SEs are primarily focused on more active consumption of information. Furthermore, SEs may be integrated within the environment in a way that extends well beyond a single, specific 3D volume (e.g., a volume enclosing a presentation stage); instead, SEs may be incorporated into an entire environment (e.g., the presentation stage as well as the entire building that holds that stage). Thus, while the SE is integrated in the environment and may be relevant to a specific location, it could also be viewed as an occurrence in time (e.g., an event).

Simulations are frequently task oriented and, as such, participant engagement within an SE lends itself to tracking certain data (e.g., performance metrics) that may be harder to define meaningfully for other forms of information consumption. For example, in the fire extinguisher training example, a participant might participate in an SE for putting out a small fire with a virtual or real fire extinguisher. Here, the information may be conveyed to this user via a “hands-on experience” of performing the actions required to fetch the fire extinguisher from its location in the environment, operate the fire extinguisher properly, and ultimately extinguish the fire. During the performance of these tasks, performance metrics of the participant may be tracked, including time to complete the exercise, success or failure in performing certain tasks and subtasks (e.g., pulling the pin on the fire extinguisher), and whether the participant was maintaining safe distances from hazards, etc.

Next, Information Scenarios or “ISs” are collections of environmentally integrated CVs or SEs. The collection might present content (e.g., CVs and SEs) in a predetermined sequence, where each element of the sequence is a group of one or more atomic elements that each consist of one or more CVs and/or SEs. These sequences can form a type of graph through which the IS author can specify the order for the content. Directionality of the graph can control the order and can, itself, be either statically defined (e.g., given by the author as a set order) or dynamically defined based on some event (e.g., actions or behaviors of the participant or other conditions such as a timing requirement).

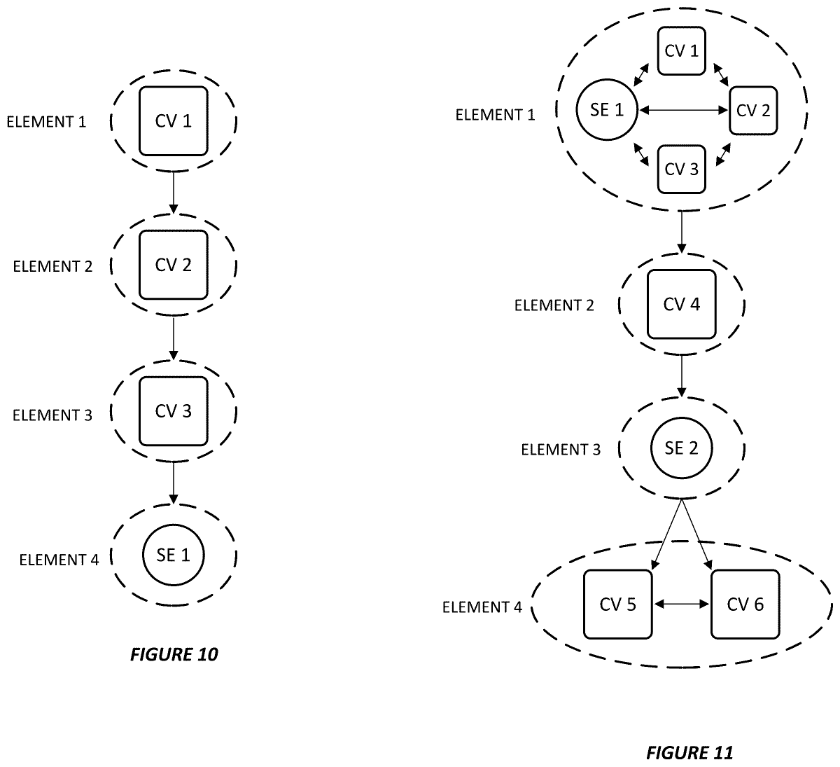

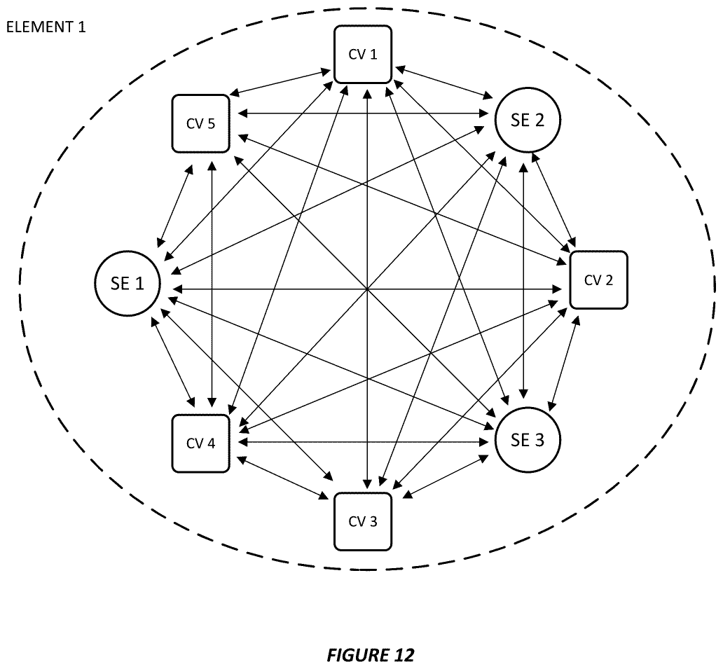

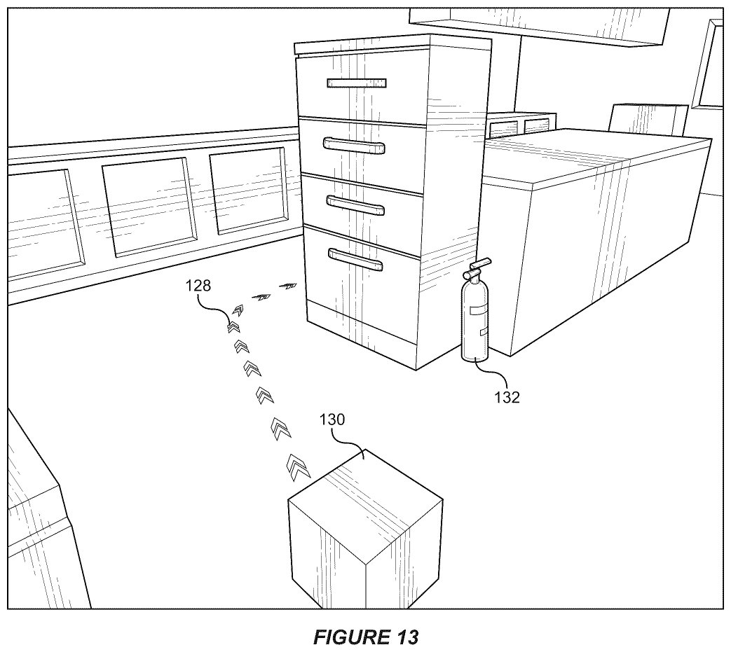

In FIGS. 10-12, graphs showing example sequences or ISs are provided. Additionally, FIG. 13 illustrates an experience having an IS formed by a CV or SE. In these cases, since the elements and their constituents are integrated into the environment, those elements and constituents might be separated from one another in space (i.e., physical or virtual space). Participants might walk between various points of interest in an environment (e.g., from a CV to an SE, from SE to SE, etc.), depending on how a particular information scenario is laid out, how the participant chooses (or is permitted) to engage with it, how it was authored, etc. For example, a participant might move from one CV or SE to another in a simple, linear and ordered sequence, as shown in FIG. 10. In other cases, such as that shown in FIG. 11, a sequence of elements is provided that includes both uni-directional and bi-directional choices, which provides a defined order in some cases and an open choice in others. In other cases, such as that shown in FIG. 12, an entirely unordered sequence is provided. In these cases, the participant might be permitted to choose any element at any time. In certain cases, as illustrated in FIG. 13, way-path indicators 128 may be beneficial for guiding participants along the sequence from one element to the next. These indicators 128 may provide audio, visual, or haptic indications of where the participant should move to next, or what paths are available in the case of multiple choices. Since these indicators 128 serve as guides, they preferably adapt to changes in available choices based on behaviors or actions (or other conditions). Additionally, a user avatar 130 might be directed by instructions or an indicator, such as indicator 128, to interact with a CV, such as fire extinguisher 132, and to then travel along a designated path and to use the fire extinguisher to an SE, such as using the fire extinguisher to extinguish a virtual fire.

Effective information conveyance is dependent on many factors, including the participants themselves, and data and analytics are key to improving effectiveness and scalability. While users participate in an IS, it is possible to collect various data points about them and their interactions. These data may include biometric information, such as eye tracking and pupil dilation, heart rate, physical motion (e.g., head and hand motion). This data can be collected by an XR device or a separate device such as a handheld device (e.g., a mobile phone) or by other sensors placed in the environment or on the user. Additional information can include demographic and other participant information, including age, job function, and other segmentation data that might be available from referencing external data sources (e.g., interests or community networks from social media). Further, data on interactions with the environment as well as with content and information within the IS may also be collected. For example, data on where the participant moves within the environment and what environmental objects are touches, especially in virtual environments, may be collected. The manner of a participant's interaction with information (i.e., including both CVs and Ess) can also be collected. This might include, for example, how long the participant spends in a CV or how long they spend on a specific portion (e.g., a slide of a lecture presentation) of an experience. In other cases, how the participant performs tasks in a simulation, their interactions with props (including what, how, and when they interact with props), and the order (i.e., sequence) of their interaction with various props, elements, or atomic elements. Other information that might be collected includes the number participants and the nature of each participant's interactions with other participants and how their interactions with the environment, content, information, etc. compares to each other or to other groups. The information described above provides several non-limiting examples of the types of information that can be used to monitor and improve the conveyance of information.

Once collected, this data can be used to inform various aspects of the IS as well as ISs created in the future. For example, the data might be used by algorithms to determine the optimal sequence of elements or the optimal placement of those elements within the environment. The data may be used to inform and improve, through algorithmic, statistical, qualitative, and/or quantitative analyses, what information is conveyed by the IS, how it is conveyed, and where it is conveyed (e.g., placement). For example, data collected on interactions by a participant with previous CVs in an IS might result in them being guided along a different ordered sequence or it may result in the replacement of a CV with an SE (e.g., where data indicates the participant's attention span, as determined by eye data, is better maintained by simulations than in lectures). Next, timing of presentations (e.g., how quickly one can skip slides) might be modified based on participant characteristics, such as accommodating different attention spans of various age groups. In the case of a multi-participant IS, placement of elements within the environment may be adjusted to group size to accommodate ideal access to information for each participant.

Finally, this collection of data can be used in the generation (or the pre-generation) of content, including by using the methods described in U.S. Pat. No. 11,645,932 as well as other generative methods such as Large Language Models and machine learning. Preferably, the creation of this content is done automatically and dynamically. This can mean pre-creation (e.g., an automated process to generate ISs for use) as well as creation on-the-fly. In the case of on-the-fly creation, the IS elements, including down to the constituents of the atomic elements and their placement, can be created in real time while the participants are within the session. This approach requires previously collected data to be available and also for data on the information that is intended to be conveyed to be available as well. Nevertheless, this removes the need for pre-created content for conveying information within an environment and allows this method to be highly scalable. Using these methods, when provided with certain initial conditions and other parameters, content can be generated on the fly with physics-based models. For example, with the fire extinguisher training, the instructor can select the type of fire, how fast it will spread, the materials that are hand to burn, how large the fire will get, etc. The acceptance criteria can also be designated. Given a set of parameters, the simulation can run until the acceptance criteria has been met, which provides the user a constrained but variable experience.

### Constrained Procedural Environment Generation in Physical Spaces

Next, gaming, entertainment, training, and simulation often need or desire to provide XR environments that are different from a user's actual physical environment. This can vary from simply providing virtual alterations to the physical environment (e.g., introducing burned materials in a building for a firefighting training simulation) to transporting a user to another world entirely (e.g., providing a fantasy world for users in a game). However, in both AR and VR, safety and convenience considerations often limit the space in which users can interact in a natural way. Additionally, spaces where these experiences take place are often small and are recommended to be cleared of obstacles that present a tripping hazard and the like. This is especially true in VR, where total occlusion of the real world can easily lead to tripping and other dangers. Even if using a small space, such as a 10 foot by 10-foot room, it is often quite difficult to provide a suitable space (i.e., that is conducive to XR experiences) and that is completely free of obstacles. In response, users may use large, dedicated facilities (e.g., warehouse-sized VR arcades), or will reserve locations for occasional use (e.g., police using a basketball court for VR training). In either case, logistics and cost considerations can lower the convenience and introduce other substantial hurdles.

One issue, however, is how to provide the same immersive environment in various large physical environments that are likely to differ substantially for each user, or spaces which are large but not free of obstacles (e.g., a large house with various rooms with furniture, rather than an open warehouse). In other words, since each large space will likely differ (at least slightly), how can a similar XR experience be provided for all users? This is generally not an issue for VR because the physical environment is neglected (i.e., occluded) and the VR content may be generated based on procedural rules that are entirely independent of the physical environment. As a result, each user may receive and interact with the same generated content regardless of their physical environment. However, even this solution may require “teleportation” of the user within the VR experience from one location to another in a similar fashion as in computer games, rather than a more natural physical interaction (i.e., walking from room to room). This teleportation process, of course, reduces the overall immersion/realism of the experience.

In AR, this issue may essentially be ignored and the burden of creating the AR environment in which the user interacts with the generated content is placed on the developer. While this process can be aided by artificial intelligence, this solution is still not convenient and suffers from a lack of immersive environment creation, especially where the changes made by AR to the physical environment are substantial (e.g., transforming an entire office into a post-apocalyptic game or training medical personnel in navigating a mostly destroyed office building following an earthquake). In those cases, the burden of creating the AR environment becomes too tedious to expect users to design and implement changes to the physical environment that would fully immerse the user.

Procedural generation of content is known in the art and offers a partial solution to this issue. However, generating content in this manner requires that behavior be controlled and for other constraints to be placed on the design. For example, in many procedurally generated video games, the layout of the generated space is restricted to a specific and predetermined overall size having a predetermined orientation. For example, doors and windows must generally be placed in walls. Additionally, the placement of objects in those cases might be limited or restricted (e.g., density cap). Since the designer is responsible for the overall design of the space, they can cause content to be generated in that space that satisfies the constraints that are imposed and that is coherent within the space. This is important for achieving design objectives (e.g., gameplay experience, training objective, difficulty, mood, etc.). For example, because the design maintains control over the space, the placement and type of lighting can be procedurally generated to achieve a desired mood (e.g., scary or happy) within the experience.

For these reasons, it has typically been necessary for the designer to maintain a full semantic understanding of the design space in order for procedural content generation to effectively generate engaging, realistic, immersive, and balanced experiences, and this semantic understanding must be present either before or as the content is procedurally generated. However, for dynamic user environments, where a semantic understanding of the design space is not available ahead of time and where the designer has no control to enforce constraints (e.g., overall size), this current procedural generation solution is inadequate.

These issues are addressed by the methods described below for procedurally generating XR content that is constrained to a physical space. In these methods, the following assumptions are made.

First, the physical space provides a hard constraint on the placement of XR (i.e., virtual) assets. To provide safe navigation in a physical space, “appropriate” XR components must be present in all places where a physical object is present. In this instance, the term “appropriate” means an XR component having a size and shape that, when placed into the physical space, fully contains (i.e., encapsulates) the physical object. Further, appropriate XR components provide at least one of a visual, auditory, or haptic indication of impassability to the user as well as logical impassability (i.e., the component is respected in the experience as being impassable, e.g., a virtual wall will prevent a user from passing through it in the same way that a physical wall does). Those appropriate XR components are the minimum number of components that must be present, but additional XR content can be placed in the physical space as well.

Second, the orientation and placement of the physical dimensions of the physical space and the objects it contains are known and can be placed in and accurately positioned and oriented with the coordinate system of the XR peripheral. This alignment process may include the use of a 3D scan, digital twin, or 3D model or other information necessary to construct such a model.

Third, it is not necessary to know “what” the physical objects in the space consist of (e.g., it is not necessary to know if the physical object in the space is a window, sofa, wall, etc.). However, it might be possible to programmatically derive certain assumed semantic information about an object from a 3D model, regardless of how it is generated, based on geometry. For example, it might be possible to discern, based on the model, what a particular component or combination of components is (e.g., floor, ceiling, wall, baseboard meeting floor, etc.). Alternatively, it may be possible to use computer vision to classify objects in a given physical space.

Now, with these assumptions in mind, the issues described above can be addressed by “painting” a given physical space with a chosen theme using XR components. As a result of this process, a given physical space may be populated with foundational and composite assets, which may include one or more CVs, SEs, and/or ISs (described previously), to provide the visual/auditory/haptic aspects that match a selected theme. The space is “painted”, or populated with the relevant assets, such that virtual assets overlay physical assets in a desired manner that also reinforces safety and other physical constraints while still achieving design, gameplay or other goals. The asset placement is spatially directed generation, that is, directed by the physical space in which they are placed.

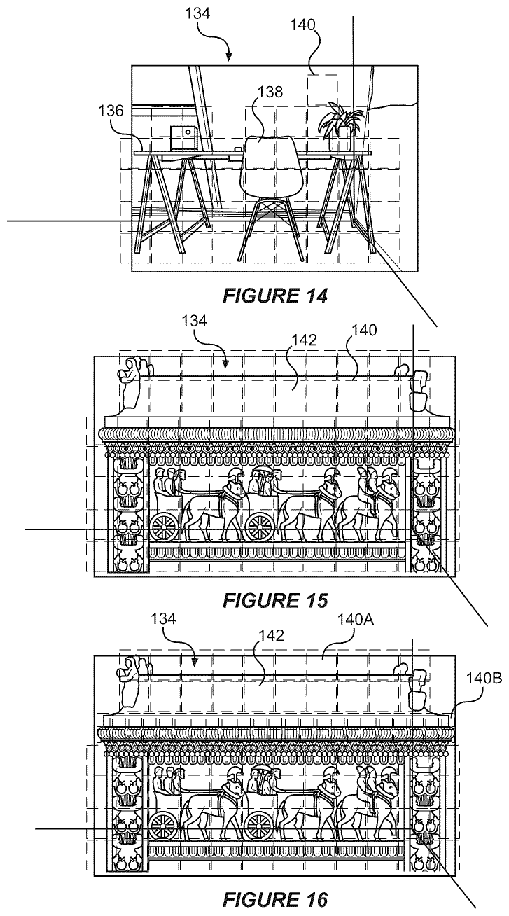

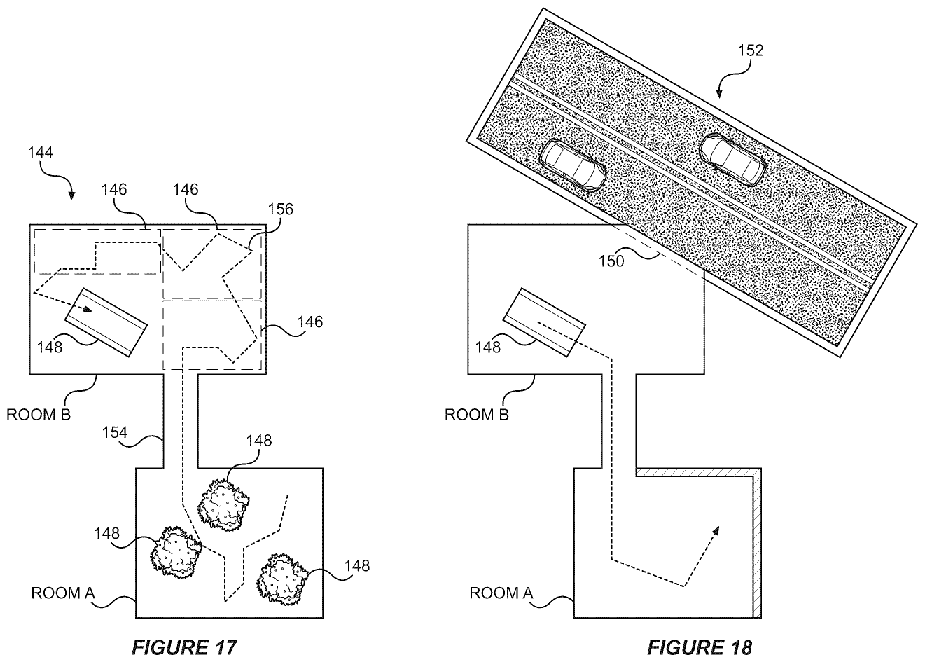

If semantic information is available, that information allows for the identification of the objects present in the physical environment. In this method, whether semantic information is available or not, the physical environment is first imaged, such as by computer vision or time of flight scanning, and then segmented into three-dimensional volumes or “characteristic cells” based on the configuration of the room and the objects located in it. For example, in FIG. 14, an image of a room 134 containing a desk 136 and a chair 138 is captured and is then divided into a plurality of characteristic cells 140. When these characteristic cells 140 are equally sized and regularly spaced, they may be called “voxels.” Then, a foundational or composite asset may be applied to each of the cells. For example, texture assets can be applied to cells located at a wall surface in order to change its appearance to a selected theme or characteristic (e.g., “wet” or “grimy” walls). In the case of a texture tile that is a foundational asset, it may be repeated over each cell or over a group of cells. It may also be alternated with different texture tiles in order to achieve a desired appearance or pattern. Similarly, props can be placed on or attached to one or more cells. Further, combinations (i.e., multiple assets) can be placed on or associated with each of the cells. For example, a single cell may be painted with both a prop and a texture asset. A single asset may occupy or span more than one cell. For example, depending on the size and positioning of the cell, a single large prop may occupy multiple cells. In FIG. 15, the characteristic cells 140 in the room 134 (shown in FIG. 13) have been painted to cause the desk 136 and chair 138 to have the appearance of Egyptian sarcophagus 142. In certain cases, the characteristics cells 140 may also be positioned dynamically with varying sizes and placement and forming part of a dynamic mesh. In such cases, cells may be given larger or smaller sizes in areas that should have lesser or greater resolution, respectively. This would, advantageously, allow the memory required to be customized and reduced where a high level of detail is not required but to be increased where a high level of detail is required. For example, as shown in FIG. 18, larger characteristic cells 140A might be used on flat walls that appear and operate along their length. On the other hand, smaller characteristics cells 140B might be provided near the lid of the sarcophagus, where a user might interact with it and greater resolution is required or helpful.

The placement of these assets may occur algorithmically (i.e., automatically) and can follow simple rules and patterns, such as “association rules.” Association rules are logical rules consisting of an antecedent and a consequent, where if the antecedent is logically satisfied, the result is the consequent (i.e., an if-then statement). Further, rules can be ordered such that an algorithm may move through an ordered list of rules and apply assets according to the first rule whose antecedent is satisfied (i.e., evaluated as “true”). The ordering of rules and the determination of the rules themselves can be determined in many ways, including rule mining which is discussed below. Alternatively, rules can be randomly selected, where sampling from the available rules continues until one is satisfied. This process can be repeated as many times as needed or desired for a given cell, either by directly repeating application to the cell or by iterating over all the cells in a desired sequence multiple times.

In each rule, the consequent itself may be a function that, for example, randomly selects the floor texture to apply more detailed logic for that selection (e.g., apply a floor texture tile that is different from the last tile applied). Further, the asset applied in each case can be generated on-the-fly, e.g., by generative machine learning approaches to provide a fully procedural approach. Next, cells and association rules can maintain a concept of order and state. Accordingly, the sequence in which cells are considered for asset application can result in different resultant generated content, which may function as an additional parameter in this procedural generation approach. Sequences may follow a variety of patterns in painting cells, including spatial or semantic patterns.

Rule mining is a machine learning approach of discovering useful association rules from data. That data could be, for example, a collection of hand-crafted or custom environments (e.g., environments that are not procedurally generated) over various layouts, whether physical or not, where the assets have been identified and the layout can be divided into characteristic cells, as described above. In certain embodiments, the data used in this process is not a three-dimensional layout; instead, the data may include written descriptions and/or images that thematically capture the goal of the procedural generation. In fact, the data could even include synthetic data, such as images of environments that are generated by automated systems (e.g., generative AI) or taken from a variety of sources (e.g., taken from the Internet), to function as a database or storehouse. The data simply needs to be processed for division into characteristic cells and the identification of assets (i.e., at a coarse or fine level) in order to identify patterns or categories of assets.

With the data, association rule mining algorithms, such as genetics algorithms, are used to find antecedent-consequent patterns based on certain criteria to define the most important relationships found in the data. While the criteria can be, and often is, domain specific, common statistical criteria include support, confidence, lift, and interestingness. Several formulations of these metrics and others exist and are known to those of skill in the art and should be chosen based on domain specifics or desired characteristics.

In addition to identifying important patterns in the data, these and other criteria may also help to improve efficiency of the rule development from a computational perspective. Association rule discovery is difficult to perform efficiently and cannot feasibly be done exhaustively across large datasets because the number of possible antecedents derived from combinations of elements (i.e., logical items to be evaluated in the antecedent) goes as 2N-1, where N is the number of possible elements. Criteria, such as those above, as well as the aforementioned algorithms and others can overcome the combinatorial complexity and elicit those rules that are most important for procedural generation.

Another method for procedurally generating association rules is “self assembly,” where local interactions for components can be defined and result in an emergent pattern or structure. Self-assembly is another method for determining which assets should be applied at a given characteristic cell and, in its simplest form, is simply interactions between cells and possible assets that might be applied to those cells.

Regardless of the specific approach used, the algorithm's development is preferably tied to and optimized for achieving specific design objectives. These might include, for example, (1) flow, which includes the cadence of events and assets, times, paths (physical and logical), and feedback (e.g., visual, auditory, haptic, etc.); (2) Metrics, which may include time to complete an objective, segmentation of space (e.g., minimum square footage or minimum square footage of a certain type); (3) Objectives, which may include visual or other indicators (including Flow and Metrics) that reinforce, drive a user towards, or otherwise focus upon tasks, goals, or locations. A procedural generation algorithm can be learned by benchmarking against these (or other) objectives, including by adding the desired design characteristics into the algorithm learning pipeline as an optimization objective. Using this approach, the algorithm that is learned from representative data optimizes how well the generated design matches those design goals. The same is true for interactions or any other method than rule-based approaches (e.g., neural networks or genetic algorithms for procedural generation).

Next, without knowledge of the user's physical environment, to aid in the selection and placement of assets, some general assumptions can be made concerning their size. For example, sofas generally have a similar overall shape and are generally sized for the average-sized person. Preferably, a catalog for each class of object is created and then, using computer vision or some other measurement to determine the dimensions, type and state of the physical object, the best assets to obfuscate the physical object may be automatically selected and placed. In some cases, additional information about the semantic items may be available (e.g., the size or color of the sofa in the physical environment). Using this method and provided that the rules for safe navigation discussed above are maintained, it is also possible to contain a single physical object (e.g., a sofa) using one or more assets, including assets that are semantically distinct from the relevant physical object, and vice versa (i.e., multiple physical objects are contained by a single asset). For example, a 6-foot-long sofa, divided into voxels, may be contained by a small virtual desk that is placed next to a virtual bookshelf such that the combination of the virtual objects contains the voxels (and, thus, the sofa).

As noted above, the asset applied does not need to semantically match the physical object. For example, depending on the objective of the procedural generation, a sofa may be replaced with a digital asset that thematically fits the content (e.g., a sci-fi computer bank). In another example, if a flat-screen television is semantically detected during the scan of a physical environment, an older CRT television may be used in its place in order to create a “retro” themed environment. As such, in this example, the semantic nature of the object is maintained, namely a television, but its thematic representation is modified. In all cases, for any type of asset, any given portion of a layout may be transformed to look entirely different from that of the physical environment, provided the physical dimensions of the real-world object or structure are contained within the selected XR asset so as to ensure safe navigation of the layout. Nevertheless, semantic information may be useful in refining thematic procedural generation, particularly if there is a desire for a user to interact with a given object (e.g., control panel placed on a wall, or a kitchen chair represented as a command chair that a user can actually sit in). Further, in AR applications, where semantic information is retained visually for the user, that semantic information may be used in generating realistic assets. For example, a sofa may burn differently than a floor. So, in an AR fire training scenario, the application of burnt textures would differ on the sofa than the floor, and even virtual mechanics such as the virtual fire interactions (e.g., burn speed and even color) may be different for different objects. Next, in addition to virtual assets, when appropriate, the user's physical surroundings may also be incorporated into the experience. For example, if the user is simulating a “Sci-fi Spaceship” and a television is present in the physical environment, that TV can be paired with the user's AR headset so that actions taken by the user could impact the virtual content that is displayed on the TV.

Similarly, structures and restrictions that are not present in the physical environment may be introduced in the generated environment. For example, the generated structure is not defined or limited by and may differ from the physical structure and walls that are not present in the physical environment may be generated and placed in the generated one. This can be leveraged to obfuscate the repetitive nature of using the same floor plan across multiple experiences, and still be spatially directed using spatially directed generation.

As an example, suppose a video game creates procedurally generated levels for a building having a specific physical floor. The game would quickly become repetitive and boring if every level that was generated utilized the exact same layout and navigable path, even if the textures and surrounding props were different. Further, certain objectives or expectations, such as expected length of play, might not be met if the same layout is used for each level. Therefore, in those cases, the time spent on the level may need to be extended (or shortened) while still respecting the constraints of the physical space. This issue may be addressed through “space obfuscation,” where the placement of digital assets forces the user to maneuver in and through the space in a particular way.

With reference to FIG. 19, with space obfuscation, a large physical space 144 can be divided into multiple smaller virtual spaces 146 (e.g., rooms, hallways, low ceilings, etc.) using virtual walls, etc. (illustrated as dashed lines in FIG. 18). In other cases, space obfuscation is provided by props 148 or other indicators that inform the user of a changed layout, such as a fence, impassable vegetation, a pile of boxes, etc. In each case, while these structures 148 will not have a one-to-one correspondence with a structure in the physical environment, they each satisfy the above-described constraints that the walls of the physical space 144 are respected and that the user can safely navigate the physical environment.

In certain cases, the walls 146 and/or props 148 used for space obfuscation are used to create obfuscated path sequences. Through the strategic placement of such assets at specific times and by dynamically changing those assets based on the user's movement and behavior, virtual paths for guiding the user through the space can be created. Obfuscated path sequences are particularly useful in small physical environments, where it may be difficult to achieve certain achievements or where it might be difficult to generate certain traveling patterns due to the constraints of the physical space 144. The purpose of this type of pathing is to cause the user to lose their orientation and placement within the physical space 144 (as if they are in a maze) and must, instead, rely on the assets to determine their location. Ideally, obfuscated path sequences will cause users to retrace their physical steps without realizing what is happening by changing the environment. As a consequence, the same physical space can be experienced by the same user multiple times, thereby resulting in a physical and mental sensation of a larger space. A user may enter a room through a doorway that corresponds to a doorway in the physical environment. The room, using virtual walls or props, is carved into a snaking hallway rather than the open room that is physically present. That hallway can be made to circle back on itself, and as the user navigates the virtually created hallway, the previous walking path can be blocked off (thus making it not apparent that the hallway has circled back). As such, by circling back to the very same doorway that they previously passed through, but now with different assets, the user can achieve a sensation of walking through a much larger space where they enter and exit from different doorways when, in fact, they have only retraced their steps to enter where they entered.

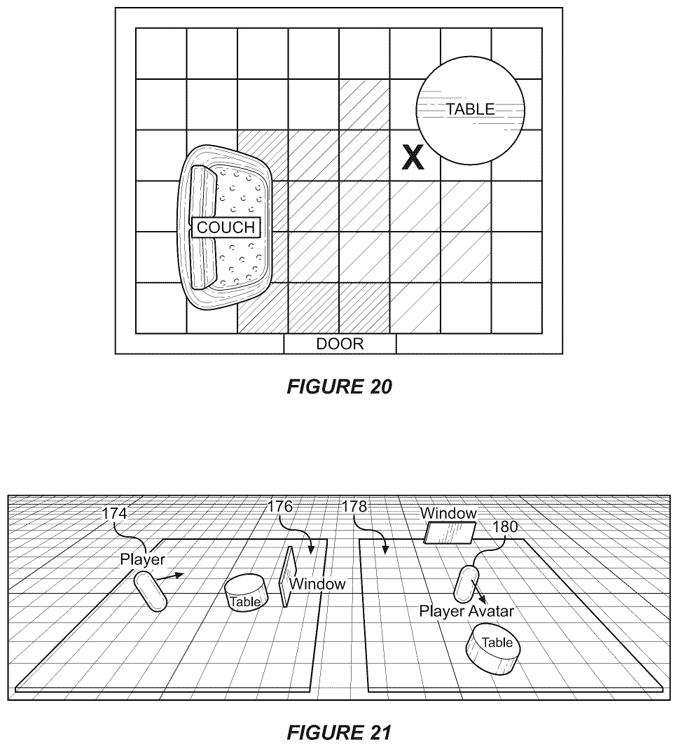

In the same way that adding assets (e.g., walls or props) can divide a physical space 144 into smaller sections through space obfuscation, a similar approach can be used to give a sensation of a larger space while still responding the physical constraints of the physical space using a process that might be termed “space expansion.” For example, with reference to FIG. 20, using space expansion, virtual windows 150 might be placed on walls that look out over a much larger virtual location 152 (e.g., consider a layout painted to look like a spaceship with windows looking out into space). Importantly, with space expansion, the larger areas 152 that are created using digital assets must remain inaccessible to users and that inaccessibility must be clearly understood by the user (e.g., using visual clues such as railings). In some cases, the expanded space 152 is not static but is, instead, dynamic and interactive. For example, the expanded space 152 could be the inside of a bunker in a battle that overlooks a battlefield that is too dangerous to enter, but that presents threats that must be neutralized (including by the user).

Returning to FIG. 19, in this example, a user begins the experience in Room A, which is initially configured to appear like a wooded area. The user then walks through a simulated hallway 154, cave, tunnel, etc., which may correspond with an actual hallway in the physical space 144 and then into Room B. In Room B, the user is caused to traverse a winding path 156 that eventually leads them to a trigger point (which is a prop 148 that is represented as a cave or tunnel in FIG. 18) that preferably obscures the user's view of the two rooms and permits the scenery of the room to be updated. As shown in FIG. 20, after passing through the trigger point, Room A is updated to now resemble a cityscape having a highway with moving cars (i.e., a space expansion) that the user is prevented from accessing by barrier wall 150.

As shown above, this process requires the dynamic generation/replacement of assets that are presented to the user at the appropriate time. Triggers for this change may include motion of the user (e.g., passing a certain point in a hallway), obscured user sight lines (e.g., once a part of a hallway is no longer visible), or other user behavior (e.g., completing some objective).

### Part 3: Shared XR Experiences

XR or “MVAR” technologies (i.e., mixed, virtual, and augmented reality) provide unique advantages for remote communication and interactions beyond what is possible with the familiar voice and video-based platforms. XR can add a sense of “presence” to collaborative, interactive, sharing, or other social settings (e.g., the sense that another attendee is physically present despite being remote). This is often considered not only one of the key benefits of XR technology, but a critical aspect for a well-designed XR experience to achieve.

Various methods have been implemented to achieve a sense of presence. These include: (1) use of 3D representations of participants (e.g., a virtual avatar) that reacts to the motions of the user in the shared virtual environment, including eye and facial movements; (2) shared content, such as a collaborative 3D model or shared experience, where the interactions of a given participant is reflected accurately within the experience for all participants (e.g., all participants seeing other participants drawing on a virtual, 3D whiteboard); and (3) shared spaces, whether purely virtual or built from importing scans of the physical world. Concerning shared spaces, while similar to shared content (and perhaps a subset of it), shared spaces are typically focused on a location for communal interactions, rather than on specific interactions themselves. In the case of shared spaces populated by scans of the real world, those participants in the scanned physical location can interact with the actual physical location and those interactions, to at least some extent, are seen by other participants (e.g., the virtual avatar may appear to be sitting on a couch).

However, these current approaches fall short for a variety of reasons. First, two participants who are not co-located (i.e., not joining an XR experience from the same physical location) are unlikely to have identical or even similar physical spaces. This results in differing physical contexts that can materially impact the quality of shared experiences, including from how participants interact (i.e., because their motions are limited by their physical space, not any virtual representation) to the quality of the sense of presence. For example, an XR avatar of one participant may appear to be sitting (or simply positioned lower than the other participants) because they are, in fact, sitting in their own physical space. However, this could appear to others as the participant sitting in a nonsensical place (e.g., there is no chair, either virtual or physical, where the person is located). This obviously breaks immersion. Current approaches aim to center the experience around shared content so that it is straightforward to accurately arrange virtual presence around a shared virtual object or to have the user manually place the virtual avatars of those not in their physical space, where the avatars are largely expected to remain mostly stationary. For example, participants may be playing a tabletop game with the gameboard being the shared content. By displaying the avatars' positions relative to the gameboard, a sense of shared presence can be achieved. However, if one participant is playing in a physical space where the actual table is up against a wall, they may be physically restricted from accessing one part of the gameboard and their avatars could then interfere with where other users place themselves. The typical social negotiation of moving around a shared table is lost and the sense of presence is reduced. This becomes even more complex when the shared content is not so easily centralized as with a gameboard, such as when avatars are placed relative to multiple shared objects that are spatially distributed. It is then quite difficult to maintain realistic physical interactions across different physical spaces.

Next, it is estimated that over 50% of communication is non-verbal (e.g., body language), which makes virtual transmission of body language a critical aspect of multi-participant experiences, especially in social settings. Much work has been done to incorporate what we term “isolated body language” via digital avatars. The term “isolated body language” refers to body language that is fully self-contained to a participant, such as how they move their head, eyes and arms, or matching virtual lip movements to their speech. Accurate relative placement of avatars is possible (such as in shared content as above), some limited interactive body language is also possible, such as spatialized audio and actions like “leaning in to speak to someone.” However, environmental body language is almost entirely lost. For example, the body language of leaning against a wall cannot be meaningfully captured because one cannot lean against a virtual wall naturally. In another example, placing one's elbows on a table that is only visible to one participant appears as a very unnatural pose to others. Even more subtle non-verbal communication, such as where one chooses to sit around a table, or positioning themselves relative to a group are impacted to varying extents without a shared physical context.

Next, memories are generated through shared context, including physical, emotional and experiential (e.g., the events of the context). Gathering at a familiar restaurant, the intimacy of dinner with friends at your house or even a cross-country road trip in an old car are excellent examples of where physical context adds dramatically to the experience and social aspects. Physical context, which in turn feeds into other forms of context, is a broad concept that includes visual, tactile, auditory and olfactory parts of the experience. Current approaches are only able to address visual and auditory (and frequently neglect auditory, though technically it can be addressed). Olfactory aspects are difficult, though there is some progress there. However, in the case of tactile there is currently no ability to add this context for participants who are not co-located because remote participation is thought to preclude tactile context by requiring shared environments to be purely virtual. However, as described below, the present invention includes methods to address this lack of shared haptics or tactile context.

Beyond the shared physical context discussed above, a more direct form of shared haptics is also frequently present in how we experience the world around us with others, and this extends to those cases where experiencing virtual content is enhanced by shared haptics. For example, consider a virtual museum exhibit where participants are able to see an accurate virtual recreation of the Apollo 11 return capsule. Humans often feel a deeper connection with historical objects when they are able to touch them. As discussed above, in other aspects of the present invention, it is possible to map a virtual object over a real object (e.g., a virtual sarcophagus over a real desk and chair) such that appropriate haptics for touching the side of the capsule could be achieved. However, the approach detailed here would allow that same experience to be shared, complete with shared haptics, across multiple participants regardless of their physical location.

Next, in AR experiences, where the physical reality is part of the experience, differing physical locations drastically impact those experiences. As a first example, suppose two friends are joining an AR social application for “virtual drinks,” each sitting at their respective dining table. Their dining tables differ dramatically in size. In this case, there is no obvious shared content, so where should the remote participant's avatar be placed? One solution might be to have the user place the location of the virtual avatar, which is convenient but clearly breaks down as soon as the remote participant decides to get up or move (i.e., their movements around their table will not have the same physical meaning around the other participants). Such movement might even include “walking through the table” if the remote participant's table is much smaller. So, again, it becomes clear that the participant is not actually located at his or her friend's table and that they are, in fact, not sharing a table at all. This reality can significantly degrade the social experience and destroy a sense of presence between the friends. In another example, consider a training exercise that takes place in a physical location, such as two fire departments attempting to train for search and rescue in a real building with AR content. In this particular case, these two departments are unable to train in the same physical location but would benefit from joint training. In this case, current approaches to virtual presence are useless, since the avatars and shared content (e.g., injured virtual people for rescue) would be entirely outside the physical context for one or both departments. Even if considering only virtual reality, this would require both departments to have an empty, open space of a minimum size in both locations to use with realistic movement.

At least some of the issues described above can be overcome through VR mechanics like “teleportation,” where the participant's physical movements are restricted to their immediate vicinity and larger movements are handled “virtually” by, in effect, moving the virtual environment around the user rather than the user around the virtual environment. But such a solution has two downsides. First, it is mostly, if not entirely, meaningless in the case of AR where a large portion of the content is the physical reality, which the application cannot move, or virtual content associated with physical locations; and (2) it completely breaks immersion and degrades the overall experience.

The present methods are focused on shared spaces in a more literal sense. Rather than simply generating shared virtual objects, those virtual objects are tied to physical objects in the real space where the participant is located (i.e., the virtual shared space is built intentionally around the semantics of the physical space). Different participants may, then, experience slightly different spaces, in order for their spaces to accurately reflect their physical environment.

According to the presently disclosed methods, all users can obtain a semantic map of their space through various means, such as spatial scanning with object detection, computer vision techniques, ingestion of semantically labeled floor plans (e.g., CAD) or manual semantic labeling of the space. This semantic understanding of the physical space is then used to generate a map of semantic overlap. This overlap is then used to find areas of both physical and semantic coincidence amongst some or, more preferably, all the participants. The term “semantic coincidence” may mean identifying where each participant has a particular type of object (e.g., a table) and the location of that object in physical relation to the rest of the mapped space. On the other hand, “physical coincidence” may mean finding areas of similar square footage or layout, such as high ceilings or large open areas. Both can, of course, be combined into various ways to find what might be termed “semantic overlap,” which accounts for commonalities in both physical layout, arrangement, object placement, object availability and even derived semantics (e.g., deducing a larger open area with a TV and a couch is likely a living room). The technical calculation may be any form of mapping, such as logical mapping, correlation, relationship mapping (e.g., graph relationships), verbal or other representation mappings or even more mathematical approaches such as latent variable mapping, affine transformations or other methods that can be used to determine what areas of participants' maps are most similar. The resulting semantic map, which holds the definitions of the shared space, might be called the “Joint Map.” The Joint Map provides information relating to the similarity, semantic overlap, and physical overlap that is used for generating a participant-specific “Local Map” (i.e., a map of the specific location from which a given participant joins an experience).

Preferably, once the commonalities are identified, an XR experience is generated, either non-procedurally generated (e.g., pre-generated or pre-determined levels or environments), procedurally, from pre-defined rules, or dynamically based on algorithmic and machine learning approaches, for each participant that maintains physical context. The level of physical context experienced depends on the level of overlap amongst the shared spaces. To that end, the XGS might recommend all participants move to a similar location in their respective physical layouts to increase or optimize this overlap since the semantic understanding of the location need not be the same for each participant and can be driven solely by the amount of semantic overlap. For example, based on semantic overlap, the XGS might recommend that Participant A move to their kitchen and that Participant B move to their bedroom (which is semantically more similar to a Participant A's kitchen compared to Participant B's bedroom). This can be particularly useful where the greatest semantic overlap is resulting from purely physical overlap, such as larger open spaces, which may occur in any given physical location.

The semantic understanding of the area also allows shared virtual content to match the physical reality of each participants' space. In general, this means the virtual content might vary somewhat from participant to participant. However, the variation in content allows for shared physical context which more greatly enhances the sense of presence than identical virtual content. Further, since the content is semantically matched, the content can maintain coherent meaning across the experience regardless of variations. For example, with reference to FIG. 21, suppose dinner and drinks are being virtually hosted. In this example, suppose Participant A sits in a first physical environment 182 at their own kitchen table 184, which is 4 feet in length, and Participant B sits in a second physical environment 186 at their own kitchen table 188, which is 8 feet in length. Participant A and Participant B are each provided with XR content. In this particular case, each is provided with an XR system 190, which may include a headset and other XR peripherals that allow them to view and interact with that content. This content may be provided by an XR generation system (XGS) 192 and communicated over a network 194. Additionally, the network 194 permits a shared XR environment between Participant A and Participant B to be provided. The XGS provides XR content for each of the participants, including first XR content 196 for Participant A and second XR content 198 for Participant B.

According to the present method, the two tables 184, 188 are semantically mapped to each other. The mapped tables act as a form of shared content. However, the virtual representation is obviously different physically and therefore the virtual representation is also different. That is, for each participant, the dimensions of the virtual representation of the table maps to their respective physical tables. For example, to Participant A, virtual table 200 appears similar in dimensions to table 184. Likewise, to Participant B, virtual table 202 appears similar in dimensions to table 188. This ensures that when Participant A sees the virtual avatar 204 of Participant B sitting in the experience, Participant B is physically mapped to the appropriate location on the other side of Participant A's (shorter) table. Similarly, when Participant B sees the virtual avatar 206 of Participant A sitting in the experience, Participant A is physically mapped to the appropriate location on the other side of Participant B's (longer) table.

Without the presently disclosed methods, if both participants sit at opposite ends, Participant A might appear to be incorrectly located in the middle of Table B from Participant B's perspective. Similarly, Participant B might appear to be far from the end of Table A from Participant A's perspective. However, using the presently disclosed semantic mapping approach, both participants will appear to be correctly positioned physically on both Table A and Table B. Not only does each participant appear in the correct position (e.g., not in the middle of the table or far away), but they are correctly scaled appropriately in order to provide the correct perspective (i.e., smaller dimensions if located further away and larger dimension is located nearer). Thus, under these methods, any given participant's physical space becomes contextually relevant to the experience for their particular perspective. This is also true for purely virtual experiences, where the virtual environment can be created to overlap the physical. Thus, a participant can lean against their actual wall, thereby exhibiting that physical body language, and other participants will witness this as the avatar leaning against a wall that is similarly represented in their location so that the body language is not odd or out of place because the context is the same.

Next, where physical mapping overlap is limited, “mixed semantic mapping” or “mixed mapping” might be used instead. Mixed mapping occurs when virtual content is introduced to provide the semantic physical context that is missing from another user's local physical space. For example, imagine Participant A leans against a wall, but Participant B has no corresponding wall in the vicinity at their location. In that case, a virtual wall can be created for Participant B's benefit for the body language to make sense. This virtual content could be generated on-the-fly (e.g., as Participant A leans against it) or pre-generated if the application determines such wall is likely to be semantically important to the interactions of Participant A (e.g., this participant leans on walls a lot). Another example might apply where physical locations have little to no similarity. For example, if Participant A joins from a crowded, small house filled with furniture, and Participant B joins from an empty warehouse. In another example, a lot of the semantic objects in one location may not be present in the other location (e.g., Participant A has several couches, but Participant B has no couch or table). A third, possibly more plausible example might be: Participant A is in a small conference room and joins a training experience with Participant B on the factory floor.

While this kind of one-to-one translation of equivalent and identical action from a person to their avatar is one example of how this concept might be implemented, this method is not limited to that one use case. In some cases, it might make sense for the avatar to show an equivalent but different response. For example, if leaning against a wall suggests that a participant is beginning to grow impatient, an equivalent gesture might be that the avatar puts their hands in their pocket and begins to tap their foot. Thus, this approach may include imputation of semantic meaning to interactions and behaviors or participants (e.g., perhaps based on attributes of the participant or behaviors outside of the session, such as gathered from social networks). This kind of imputed semantic meaning is not limited to pure VR experiences but could be used in any XR implementation.

As shown above, in Joint Mapping or shared semantic mapping, it might not be possible to provide one-to-one analogues across all spaces. However, by mapping semantic and physical aspects of the space across participants, such analogues are not needed to achieve truly shared experiences. Instead, interactions are mapped to an appropriate representation in the other participants' Local Maps. Provided that the mapping of the interaction or behavior maintains the same meaning, generates the same engagement or otherwise provides the same implication, effect, sensation, context or message in the experience, it can achieve the enhanced sense of presence and social activity missing from other approaches. For example, consider the individual leaning against a wall as a sign of impatience. As noted elsewhere, the presently described methods can just as easily introduce that interaction against a table or against a virtual wall so as to maintain realistic context with the participant's avatar's motion in other spaces. However, consider the case where neither a table nor a wall is present, and introduction of a virtual wall is not possible (for whatever reason). In this case, a further layer of abstraction can be introduced to the mapping. For those Local Maps where the actual interaction cannot be replicated in a meaningful way, the avatar might be displayed in another expression that is appropriate for the space and still conveys the same message, such as crossing arms or tapping a foot to display impatience.

This, of course, requires that this approach include the ability to impute the “meaning” of various interactions from participants, such that they can be mapped appropriately. Several options for this exist, such as providing participants with any type of user interface that allows them to, for example, pick an emotional state or assign a meaning to a particular interaction. A more advanced implementation may include estimation of participant intent, emotional state, or other signal (or combination thereof) that allows the mapping system to infer the meaning of interactions. Such a system might make use of participant data, including without limitation prior behaviors, prior assignment of meaning to interactions (if any), previously provided participant attributes (e.g., provided via a mobile application or derived from external sources such as social media networks, online behavior or any other data source). Specific implementations of this method can take many forms, such as, without limitation, machine learning approaches to classification of interaction meaning that takes as input participant data and the current interaction the participant is engaging with to output the estimated intent or meaning of said interaction.

By mapping virtual content to create the Joint Map and using the Joint Map to anchor user interactions across this content which in turn is translated to the Local Map, participants are able to have physical context in a true “shared space” by using the Joint Map as a layer of translation between their respective physical spaces. The above-mentioned additions (e.g., mixed mapping) merely add to this baseline capability in various ways.

As a further example, returning to the two fire departments that cannot train in the same physical location, since a one-to-one analogue in the two spaces is not necessary, the Joint Mapping approach can allow them to train together in two different buildings. In this example, assume Fire Department A (“FD A”) trains in a building with hallways running East-to-West from the main entrance, while Fire Department B (“FD B”) trains in a building with a hallway running North from the entrance and a second running West from the entrance. Now consider a training experience that is abstracted in the Joint Map to simply be “two injured people are present at the end of one hallway, and another hallway has a fire blocking access.” With the presently-described methods, the fact that the hallways of the buildings are oriented differently (i.e., not just cartographically, but one building has hallways in a single line vs. a right angle) makes no difference to the experience, and FD A and FD B can both train together—including having the remote participants correctly mapped to the relevant locations as they walk down the hallways together.

Now, returning to the dinner example, the following steps are carried out in the presently described methods. The scans of each participants' locations are compared and analyzed in order to generate the Joint Map. In this simple case, the Joint Map consists of identifying the semantic overlap between the kitchen tables present in each space. In this example, the table provides the anchor for the interactions and so it is mapped to the Joint Map that connects each participant's Local Map together. As such, interactions are mapped to their position, scale, orientation or other property relative to the table. The interactions' mappings to the Joint Map are then transmitted to each participant where they are translated to be relative to the Local Maps' representations of Table A and Table B for accurate alignment in the local space of each participant.

As a result of this process, each user can safely interact with the other while located in their own physical space. In the case of AR, each participant's physical space is preferably well integrated into the experience. In the case of VR, the virtual space is safe to walk around and interact with naturally as it matches one-to-one with the physical world. Next, while each of the participants' spaces might differ, interactions are seamlessly integrated into their Local Map, which allows for semantically and physically accurate representations of shared content and interactions despite being in different physical locations. By uncovering overlap when generating the Joint Map, experiences can be in a truly shared space regardless of location. By incorporating the physical space in the Local Map, natural body language is enhanced (e.g., leaning on a table or wall), experiences gain a shared physical context and gain shared haptics that greatly enhance the social and collaborative aspects of the experience. Through the use of mixed mapping, even where physical objects are absent or otherwise located in the Local Map, remote participant body language can remain naturally represented in a coherent shared context.

Next, by considering multiple maps, recommendations can be made to the end users that relate to areas that are mutually conducive to an optimal user experience. This may be accomplished using multiple methods, including by considering the largest open areas or by using machine learning to determine which areas of a map are most alike. This process can be extended further by considering the placement of avatars and by making recommendations of interactions or behaviors to the users. For example, assume 3 participants have a table that is accessible from all sides. However, a 4th participant only has a table that is located against a wall such that at least one side of the table is not accessible. A recommendation may be made to all participants regarding their arrangement around the table such that the 4th participant is not precluded from a reasonable experience because of the furniture's position (e.g., the only remaining open position for the 4th participant is located on the blocked side of the table). Recommendations could also be extended to interactions and types of experiences (e.g., recommending a tabletop game, virtual or otherwise, that does not require the users to move around the table). In certain cases, placement and arrangement of users could be handled automatically. That is, the translation of the virtual avatars to the Local Map could automatically optimize for the ideal arrangement for the local participant. In the example above, the first 3 participants might be automatically arranged in the Local Map for the 4th participant such that the 4th participant need not worry about access to one side of their table.

Generating the Joint Map, including for mixed mapping and non-mixed mapping (i.e., when additional virtual aspects are not introduced), can include optimization based on participant attributes and behaviors. For example, over several sessions it may be recognized that a participant tends to make use of certain types of furniture (e.g., always sitting). In other cases, by looking at large networks of relationships, it may be discovered that participant groups with certain attributes (e.g., relationships, demographics, etc.) optimize a particular set of metrics (e.g., length of session, frequency of sessions, “enjoyment” or engagement) when participating with Joint Map's with certain characteristics (e.g., Group A has maximal engagement when in a Joint Map with two couches or at least 100 sq. ft. of free space). This form of analysis can inform everything from how similarity is measured in generating the Joint Map, what rooms might be recommended for use in the Joint Map from all participant scans, and what virtual objects might be added (i.e., either at generation or dynamically) for mixed mapping.

These concepts can be extended beyond a single XR experience session. Over time, it is possible to learn where individuals might prefer to walk or sit within their space. This information may then be used to assist in orienting the spaces of others. For example, if Participant A continually moves between two points in a space, Participant B's space might be arranged so that they are less likely to collide with Participant A. In certain cases, a heat map of where participants tend to move within their space can be created. Since physical collisions are impossible between virtual avatars, these heat maps may be used to orient the maps so that there is minimal overlap between two avatars while allowing participants to move freely as possible without having to consider this aspect of their experience. It is also possible to designate “no go zones,” where one user's environment might have an object or structure (e.g., a piece of furniture) that might not be present in the other user's environment. In such cases, it is possible to “translate” the first user's perception of where the second user is located in their space so that the second user does not appear to walk through that object or structure. While not required for a usable user experience, these types of considerations can improve the user experience at no cost to the end user (i.e., the end user is not required to answer questions or manually designate anything).

In certain embodiments, beyond physical and semantic mapping, interaction mapping and temporal mapping are also considered. As used herein, “interaction mapping” means finding the forms of interactions that are common amongst participants, either derived from attributes or prior session experiences. For example, Participant A may frequently lean against a wall, but a wall might not be available across other participant layouts. However, the same or at least a similar interaction might be replicable by leaning against a table that is common across other participant locations such that the leaning body language is consistently contextual across the Local Maps. In other cases, where a wall or table are not present, the participant might lean on a different object. Thus, similarly, interactions such as playing games that take a minimum amount of space, or gathering around a central location can inform the Joint Map. For example, a central gathering location may be the semantic representation in the Joint Map, but this could translate to a table for Participant A but a fire pit for Participant B. Or the amount of space needed for a game could be mapped to various layouts across different participant locations.

On the other hand, “temporal mapping” considers participants who may be in the same location, but at different times. For example, multiple participants may share in the experience of a museum exhibit but are unable to share in that experience at the same time. In this case, the Joint Map is developed based on the interactions of participants along with, optionally, where those interactions take place spatially. As subsequent participants engage in the experience, the temporal Joint Map may enable the interactions of prior participants to be replayed as the current participant approaches the same virtual or physical content/locations. For example, the prior participants' avatars could be spawned and display the prior interactions for the current participant, simulating as if they shared the experience together. Extending this concept with intelligent machine learning or artificial intelligence, the avatars in this example could even interact directly with the participant, responding to their engagement beyond simple replay. Next, interactions by prior participants can induce alterations in the content. In the case of AR, this might mean changing what, where and how virtual content is integrated into the physical environment based, for example, on commonality of paths taken by prior participants. In fact, these alterations may be such that they induce the current participant to take the same path as (or intentionally a different path from) prior participants, depending on the objective of the experience. In the case of VR, the content and environment might be changed to achieve matching, lack of matching or some juxtaposition of interaction between the current participant and prior participants.

These methods can be forward looking in time as well in terms of engagement objectives with an experience. In other words, altercations can be implemented and designed (including on the fly) such that subsequent participants have a particular experience based on the interactions and actions of the current participant. This may require a probabilistic approach, as the exact interactions a participant will make cannot be known beforehand with complete certainty.

Finally, temporal mapping may consider real-time (i.e., within the current session) mapping of participants. Revisiting the idea of a museum, in certain embodiments, it is possible to combine several of the ideas above to help control flow and minimize undesirable effects, such as phasing through avatars. Flow control is already a large part of the design consideration for physical museums, rooms have multiple points of ingress/egress and often vary thematically so people have choices on where they go next. In the context of the presently described invention, current foot traffic may be used to determine the starting point of the participant in an area of the room that has low participant density. Additionally, in certain cases, instead of having a fixed destination for each point of egress, it is possible to transition the participant into a region of lower or higher traffic depending on the desired experience that the exhibit creator has in mind, or the participant signs up for.

In the usual approach to spatial alignment of virtual content, or alignment of multiple users in a virtual setting, physical fiducials are often used to allow for the generation of a common coordinate system. This is necessary because XR devices (and other spatially tracked devices) do not necessarily share a coordinate system, requiring a mapping from one device's coordinates to another for devices and virtual content are represented in the appropriate locations, aligned to either other virtual content/users (including user avatars) or the physical environment, or both. Commonly, these physical fiducials are termed “anchors” and in effect use the physical world as a source of “ground truth” for device coordinate systems that allows such a mapping to be created. Device may differ in the coordinates assigned to the fiducials because of their differing coordinate systems, but because the fiducials are known to exist in the same physical location the device-assigned locations (within their respective coordinate system) can be known to correspond one-to-one with the location assigned by other devices. However, these traditional mapping of physical coordinate systems or reference frames are insufficient to ensure movement of one user in one physical space or environment is correctly and consistently mapped to the semantic meaning of the movement in another physical space or environment.

As discussed above, semantic mapping allows the motions, interactions and behaviors of a user in an XR environment to be represented in a manner that reflects the intent of the user in a semantic relationship, even if in physically different environments. For example, a user who approaches a couch to sit down in their own physical space may be represented as an avatar to other, non-co-located users approaching and sitting on a couch in that remote user's space-even (and especially) when the couches have no physical relationship. The question then is what anchors should be used and when should they be used to successfully map semantic behaviors across multiple physical environments/spaces? The term “anchor” is used here to mean a common point of reference. However, in this case (i.e., with semantic mapping), the common point of reference need not rely on the physical environment as the system of record. Rather semantics and interactions provide the source of ground truth, and as such the relevant anchor(s) for mapping across coordinates (both in devices and physical locations now) may change over time based on the experience, semantics and users.

In one embodiment, the semantic anchors used to place the virtual representation of a user in a remote space (i.e., one that maintains meaningful semantic relationships) are a subset of all the semantic anchors. This subset is determined by predicting the target or focus of a user's motion or other behavior. In some cases, all (or a subset of) anchors could be used where the anchor's importance and influence (i.e., how it is used, and its impact on the mapping) is weighted. Weights may also be a priority (e.g., to ensure mapping to one anchor is prioritized over another). The weights may be determined based on the predicted intent of the user(s), and/or the target(s).

The intent or target may be based on virtual content. That is, objects, focus, objectives, interactables, tasks or other goals, aspects or content within the experience. These may serve as the meaningful semantic anchors. That is, a chess board (i.e., the central focus of the game) may be placed on a table, but rather than considering the table the semantic anchor, the chess board may be the anchor. Thus, the anchor of the semantic interactions would remain the chess board even if in one environment the user places it on a desk, whereas users in other environments place it on a table, bar or even the floor.

In these cases, interactions with semantic objects are viewed as the observed ground truth. One may formulate a concept of this system such that the semantic objects or the interactions with them are observables or boundary conditions. The mapping of movement at remote environments is uncertain, with certainty only coming upon interaction with a semantic anchor. As such, the movement of the avatar in space is estimated, with estimates becoming more accurate as the user approaches a semantic anchor and ultimately interacts with it. This is, in part, because the intent of the users' movements (or their target) cannot be concretely known until the users confirm it through interaction.

One might view this like a path finding problem or a wave equation. Given two pins along a string, several waves can be generated. The position of a bead along the string depends on the wave. However, the span of possible positions, regardless of wave, decreases as one approaches a pin on the string. Similarly, the possible paths between two points can be numerous. The specific location of an object traveling between two points depends on the path chosen and so is uncertain. However, the span of possible positions necessarily narrows as any of those paths approach the end point. This type of approach can be leveraged to predict the position of the avatar in a remote environment relative to semantic anchors, especially where one can predict the target semantic anchor of the motion (i.e., the pin in the string or target point to traverse to).

To determine the target or focus of the movement or behavior, or to determine the subset of meaningful semantic anchors at any given time (including a subset of one), or to determine the weighting of semantic anchors or a subset of anchors one could, in a particular manifestation, base it on inferred intent of the user. This intent can be inferred many ways, and target prediction and target selection are studied in many other fields known to persons of skill in the art. For example, statistical approaches, such as Bayesian and other methods, as well as analytical and machine learning approaches can be used. For example, one might use observations of the user over time, such as where and what they are looking at, their direction of travel, their speed of travel or even if targets are “reachable” as a set of inputs to a target estimation algorithm. In this example, the algorithm may be statistical. The target semantic anchor may then be taken as the target with the highest probability given some set of inputs or observations. Additionally, observation of users may also provide meaningful information for inferring intent. For example, eye tracking reveals where a user's gaze is focused, verbal intent data may include a user talking about what anchor they are approaching or talking about other anchors that are meaningful (e.g., statements about needing to sit down might indicate a chair semantic anchor being the target). Even scenario/game/session mechanics, content, data or other particulars may be used as input. For example, if the next step in a game involves approaching a particular semantic anchor, the state of the user and the game provides a strong input for predicting the target. Another approach is to use the user's past behavior to train a model from which inferences may be derived. In this case, inference could be a heat map of probable destinations when given, for example, the user's current position and velocity. In this example, in addition to the pathing information obtained, the frequency at which the user chooses a particular semantic anchor as their destination given their current state is also relevant as well.

The inferred intent problem discussed above may be viewed as a path optimization problem, where the optimal path is based on the current state (including, for example, movement, velocity, momentum, heading, distance from anchors, verbal or other indicators of intent, or even experience/scenario/game or another context). Based on the current state, the “cost” of a path joining a user's current position to a given semantic anchor may be calculated. The specifics of such an approach will depend on the state of the system as well as the variables and the associated weights that are included in that state. Target intent might be inferred from the set of possible paths, for example, by choosing the semantic anchor(s) with the lowest cost path(s) to the user. Additionally, given a selected target, the optimal path(s) can be used to simulate the movement in a manner that predicts actual movement and, therefore, may be highly representative of actual movement if the user had been in the given physical environment. This could be achieved by calculating the path costs in each other's environment and then making an assumption that if the user takes the optimal path in their own environment, their avatar should take the optimal path in other environments. This is a non-limiting example of one possible approach. We note that other approaches may be taken, including approaches that consider the user of multiple semantic anchors, used in any variety of combinations.

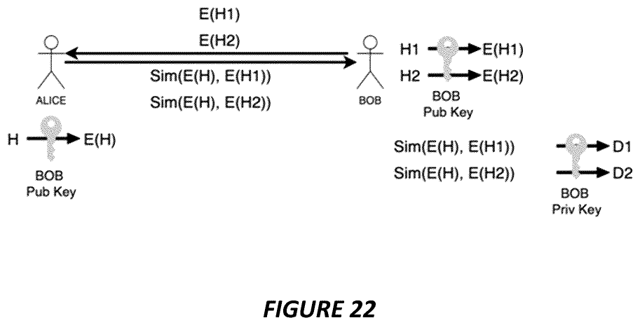

With reference to FIG. 22, a grid-based example of possible paths from the user's current location X by the TABLE semantic anchor to either a COUCH semantic anchor or a DOOR semantic anchor. The shading ranges from no shading to very dark shading and indicates the cost of moving to a semantic anchor. In this case, the darker the shading the lower the cost and the lighter the shading the higher the cost. This type of graphical approach (and other similar approaches) can help with breaking degeneracies in the position estimate of a virtual avatar in another physical space.

In another example, with reference to FIG. 23, the left portion of the image shows a user 174 in their own physical environment 176 with two semantic labeled anchors TABLE and WINDOW. The right portion of the image shows a second, remote physical environment 178 having a virtual avatar 180 and also having two semantic labeled anchors TABLE and WINDOW. In each portion of the image, arrows extending from the user 174 and the avatar 180 represent their current heading. If only the Table is used as a semantic anchor, we would expect the Avatar 180 to move towards/away from the Table as the user 174 moves towards/away from Table. This is a trivial and obvious case that closely resembles purely spatial coordinate alignments. However, this becomes much more complex if we also include the Window as a semantic anchor. The consideration of multiple semantic anchors is both important and likely to exist for any but the most simplistic of applications, especially in multiuser experiences that include more than a single focal point. When considering both the Table and Window semantic anchors, when user 174 is facing and moving towards Table, they are also facing and moving towards the Window. This is a degeneracy that is broken explicitly in the remote environment 178. Avatar cannot face or move towards Table in remote environment 178 while also facing or moving towards Window. Therefore, in such a scenario, which semantic anchor (or combination of anchors, e.g., in a multi-anchor situation) should be used or prioritized in representing the avatar's 180 motion in the remote environment 178? The answer depends on which of the two anchors the user 174 intends as their target. Upon interaction with a semantic anchor (e.g., playing a virtual game of chess on the Table), we have direct observation of the User's intent. However, prior to that, we must infer target intent and adjust accordingly. As the user gets closer to one of the two semantic anchors, that inference should become more certain. For example, if the user 174 begins to travel around Table, such motion can increase the probability that the user's target is Window. As a further result of such motion, the Avatar's pathing can be adjusted accordingly (i.e., motion towards window should be prioritized). It is noted here that, in the special cases of (1) no degenerate semantic anchors or (2) all degeneracies are shared in all physical environments, the above-described problem becomes much simpler.

As discussed above, in some cases, one may wish to engage in an XR experience that is shared with other users not in the same physical environment, but still makes appropriate use of each users' local environment. In such cases, one way of increasing a sense of presence is through Semantic Mapping, where interactions, including movement, of virtual representations of other users are mapped to their semantic behaviors rather than to their physical environments. For example, if User A and User B are in a shared experience while each remains located at in their respective house. User A might move from sitting on a couch to a table with food in their own house. In response, User B might see a virtual representation of User A (e.g., an avatar) move from a recliner chair in User B's house to a table in User B's house-all despite relative layouts of the houses being entirely different. This is because Semantic Mapping is mapping the semantic meaning of behaviors, actions and interactions rather than their purely spatial relationships. This is done using the concept of Semantic Anchors discussed above.

In order to perform this mapping, it is necessary for User A and User B to have information derived from the other's spatial environments. For example, how do we know to map the reclining chair in User B's house to the couch in User's A? Next, how are semantic conflicts resolved if multiple objects of the same semantic meaning are present. For example, if User A has two couches, or two tables, which are mapped to the single couch and single table in User B's house? Even given matching semantic classes, how do we guard against matching inappropriate uses (e.g., consider two objects of the semantic class “table”, but one is a sub-class coffee table, and one is a sub-class dinner table). In such cases, it is preferable to match behaviors to the appropriate sub class even if the sub class label itself is unavailable.

The concept of “semantic matching” may be used to address these and similar concerns. Semantic matching can be performed ahead of time (i.e., to provide pre-generated matches) as well as at runtime or in real-time (i.e., to provide real-time matches). In the case of pre-generated matches, we only consider those aspects of semantic objects that are immutable during a given XR experience or session. This might include semantic labels and sub labels, position and orientation (including relative to other objects) of a semantic object, dimensions of a semantic object, position and orientation of semantic objects to virtual content in the XR experience, and usage of the object in the XR experience (e.g., used for displaying certain content or affecting certain mechanics). Importantly, the features used in matching can be determined once at a selected time in the XR session (e.g., at the beginning or other appropriate time), and will not change throughout the remainder of the experience (and/or changes to the feature need not be considered).

On the other hand, in cases of real-time matching, features might change, update, or be influenced by actions, behaviors, events, interactions, data or happenings during the XR experience or session. For example, the context of user behaviors may be considered, such as if another User C has an avatar already sitting at the first couch in house A, User B may preferably match to the second couch in house A. In this example, the context of User C already being present becomes a contextual feature. In another example, if User A sits on their couch in house A facing a TV, then that couch might be preferably matched to a couch in House B that also faces a TV. In this case, the context of User A and the relative positions of all other semantic objects are additional contextual features. The relative orientations and positions of other semantic objects to virtual objects and the user over time is also a set of features that changes over time—including if physical or virtual objects are moved.

Preferably, even in the case of seemingly immutable features, if evaluated in a contextual fashion, may change the mapping. For example, depending on the activity of the user, the dimensions of semantic objects might be included differently as features (e.g., different weighting on each dimension depending on activity). Imagine User A approaches a table in House A to get a “virtual cup of coffee.” In this case, the additional context feature is how the table is being used—it would then be preferably matched to a sitting table in House B by having the height dimension more heavily weighted. However, that same feature of object dimensions could change the matching if the value of the feature (i.e., the reason the user is approaching the table) is to play a virtual game of chess. In that case, the height of the table may be less relevant, and the table is equally likely to be matched to a coffee table as a dinner table. As shown above, when providing real-time matching, the matching of semantic objects is preferably not based on a single point in time. Instead, the matching should be carried out in real-time (e.g., continuously, as the result of an event, or at regular intervals). In that way, the matching process is more dynamic and is also fundamentally different from the method used for pre-generated matches.

To carry out the matching process, when given a set of features for each semantic object in one physical environment (e.g., House A), a similarity score of those features to each set of features for all semantic objects in another physical environment (e.g., House B) is computed. Preferably, semantic objects are matched across the two environments by selecting the semantic object in the second environment that returns the highest similarity score for a given object in the first environment. For example, each given semantic object in House A is matched to the object in House B that returns the highest similarity score when features are compared. The specific form of the similarity calculation can be any method at the discretion of the implementer that achieves the desired concept of “similarity.” For example, this may be a mathematical process, or it may be a step-by-step decision process similar to a decision tree, or a combination thereof, or any other method. For example, filtering on semantic class (e.g., only calculated similarity between objects of class “couch” or “seating”), or comparing semantic synonyms (a “love seat” may be considered the same as a “couch”). While these and other similar limitations may be applied in certain cases, including the examples given above, they are not necessarily applied in all cases. In general, it is anticipated that this matching process will produce a mapping that relates the set of semantic objects in House A (Set A) to the set of semantic objects in House B (Set B). In the case of ties (i.e., multiple objects with the same similarity score), a tie-breaking criterion can be introduced to ensure this single-image requirement is met. This tie-breaking criterion may vary from a simple or random selection to selections that are informed by the desired XR experience outcomes or interactions or may include any other tie-breaking method. In certain cases, the single-image rule above can be relaxed. For example, where an element of Set A has no image under Set B, there is no match for a given object between the two sets. This could happen, for example, if a minimum similarity threshold is required to produce a map and that threshold is never met. Stochastic matching could be used in this case (e.g., randomly mapping this element without similarity), the element could simply be ignored/removed in the mapping, or some other method could be used. In another case, an element of Set A has multiple images under Set B. While this could be generally allowed in the definition of the methodology, it should be handled in practical terms. This could be, for example, through tie-breaking criteria, random selection, or another method that allows for one element of Set B to be chosen at a given instance. Finally, it is noted that a mapping from Set A to Set B need not be the same as the mapping from Set B to Set A. For example, when User A moves to Couch A, which in turn shows Avatar A in House B move towards its matched object Chair B, this does not necessarily mean that movement of User B towards Chair B will result in Avatar B in House A moving towards Couch A.

### Privacy Preservation

In the above-described matching process, a similarity between features in two different environments is identified. A straightforward method for carrying out such a matching process would be to fully share all details of both House A and House B with both User A and User B. However, sharing such information, even if reduced from the full spatial data or abstracted, can introduce privacy concerns. For example, User A may not want User B to know that they have a couch or the size of the couch they have. Therefore, what is needed is a privacy-preserving method for matching where users do not need to have any direct knowledge of the other's space. Such a method would permit, for example, one user to invite another user into their home virtually without the fear of sharing the privacy of that home. The matching of semantic objects amongst a group of users or spaces can be achieved via Secure Multi-Party Communication (SMPC). SMPC is a form of cryptography that allows for parties to jointly compute a function over their inputs while keeping those inputs private. Thus, SMPC may be used to compute similarity of objects for matching by taking, as inputs, various types of features while also keeping those features private. In using SMPC for this process, each user shares an encrypted or otherwise obfuscated form of their inputs (“private inputs”) that provides the same information that would have been provided by actual, non-encrypted, non-obfuscated inputs (“non-private inputs”). Any method of encryption can be used in this process. The specific encryption used should be decided in the context of the overall security posture of the system and users, as well as security and privacy needs. Without limiting the scope of this disclosure, we note homomorphic encryption can be particularly useful in this process. Homomorphic encryption is a form of encryption that allows computations to be performed on encrypted data without first having to decrypt it. Most encryption is only partially homomorphic, meaning operations on encrypted data is only invariant from that on decrypted data for some limited set of operations.

The operations performed on private inputs need not be (and, in most cases, are not) the same as those that would be performed on the non-private inputs, but the resulting information that is derived is equivalent. For example, a group of friends can determine their average salary without sharing specifics of their salaries with each other through a series of adding and subtracting random numbers to their salaries before passing the private inputs to each other in a particular order. The average of the resulting private numbers, if done in the right order, is the same as the average of the actual salaries.

There are several encryption methods that are homomorphic under addition. For example, using one of these methods, a group of 3 friends can determine the total amount of money raised at a charity event without revealing how much everyone raised. This is because, for some encryption method E that is homomorphic, under addition: E(A$)+E(B$)+E(C$)=E(A$+B$+C$), where A$, B$ and C$ are the amounts raised by individuals A, B, and C, respectively. The total raised is then D(E(A$)+E(B$)+E(C$))=D(E(A$+B$+C$))=A$+B$+C$, where D is the decryption of E. Thus, the total value can be known while the friends only tell each other the encrypted values E(A$), E(B$), E(C$)—keeping their actual individual amounts private. This process relies, in part, on the fact that knowing the total A$+B$+C$ is insufficient to know the individual components. Even though each friend will know one component (i.e., their own contribution), they still lack sufficient information to deduce the specific values of the other two components, provided there is no collusion amongst the parties. However, should Friend A and Friend B collude to share their specific values with each other, they can deduce C$ without Friend C's knowledge. While this may not be the case for all implementations of SMPC, as it is for this simple example, the concept of a maximum number of misbehaving or malicious parties is common in SMPC.

The presently disclosed methods contemplate the use of any implementation of SMPC and homomorphic encryption, and other approaches, for the preservation of privacy when comparing semantic object features for the purpose of semantic object matching. A variety of encryption methods are known in the art. Preferably, selecting and using one of these known encryption methods or other encryption methods provides a means for secure communication between two parties, a strong incentive and, therefore, protection against malicious sharing of private information. This is the case because the only information that either party knows is their own. Thus, through malicious sharing, that party would be choosing to violate their own privacy.

Two friends, Alice and Bob, who, despite claiming to be friends, do not want each other to know anything about their respective houses. Without limiting the scope of this disclosure, in this example, we assume the encryption method used employs public/private keys. Within the XR experience, Alice moves towards the actual physical couch in her house. Her virtual avatar, which is present in Bob's house, needs to know which of Bob's semantic objects to move towards to accurately represent Alice's motion in his local environment. The procedure described below will show how that matching is possible in a privacy preserving way, and of course can be repeated and/or extended for all the semantic objects and for Bob's avatar's motion as well. This method may be readily extended to either the pre-generated or real-time matching described above.

As a first step, one friend (e.g., Bob) shares their public key BOB with Alice so that Alice might use it to send encrypted information. As shown in FIG. 24, using this same BOB public key, Bob preferably encrypts the feature sets for all the semantic objects in his space (e.g., E(H1) and E(H2)) and sends those encrypted sets to Alice. Alice now has the features, but as they are encrypted, she knows nothing about them or Bob's house. Then Alice, using Bob's public key BOB, encrypts the feature set H for her couch, resulting in E(H). She can then compute an encrypted similarity score between her couch and each of the encrypted semantic object feature sets Bob sent. She sends these encrypted scores {E(score)} back to Bob, who decrypts each using his private key to see which of his semantic objects has the highest score (and, therefore, is the semantic match). This process might require the use of the tie-breaking or other approaches discussed above. The semantic match is then provided to Alice's avatar so that it might maneuver appropriately in the local physical space.

Here, we note that the above-described method assumes the encryption is homomorphic under the operations of the similarity metric. Further, this method assumes that Bob has knowledge of his own semantic features, and that the similarity score is insufficient to reliably calculate Alice's feature set. Next, it is noted that Alice's avatar is not Alice. The avatar's motions, etc. are presumed local to Bob and computed on his device. This, therefore, keeps his semantic objects private from the actual Alice. However, alternative methods other than keeping calculations local to Bob's device can be used for this purpose. Finally, this procedure is preferably repeated for all semantic objects in Alice's house and is also performed from the other direction to match Bob's semantic objects to Alice's for Bob's avatar.

In certain embodiments, non-invertible similarity measures can be used (measures where, for example, knowledge of one of the two inputs is insufficient to calculate the other input). Thus, when applied to the example above, Bob could not invert the similarity score to discover Alice's features and her privacy is preserved. Of course, other methods and measures can achieve similar privacy preserving outcomes. Additionally, these methods can be extended, pairwise and otherwise, to more than two parties as well. We note that by using a pairwise approach the incentive against malicious actors is preserved even for larger groups (e.g., Bob does the same exchange with Alice, Candice, and Dave individually).

In certain embodiments, one possible approach is to use a “trusted third party” for keeping knowledge of individuals' environments secret. In that case, the individuals might transmit the information of their semantic objects to a third party, such as a central server or mutual friend, that they each trust. This third party would perform the matching and return only the results necessary to the individuals and maintain their privacy. This procedure has the benefit of being far simpler and offering a full possibility of all matching approaches (because there is no need for a matching method to satisfy anything regarding homomorphic encryption or irreversibility).

In this procedure, privacy in the transfer of information would, of course, need to also be considered. Of course, the same type of SMPC approach mentioned above could also be done with a third party. However, the use of SMPC with a trusted third party increases the likelihood of one-party misbehaving because it removes the strong incentive that is provided in a two-party exchange (e.g., the third friend may be malicious). Second, with or without the use of SMPC, the third party may be compromised (e.g., bribed, hacked, etc.), which is, perhaps, the biggest concern of using a third party. Additionally, if SMPC is not used with a third party the method cannot be fully privacy-preserving as the third party will have knowledge of the local environment of one or more of the other parties. In the case of physical privacy, this may be asking too much of users, where it is known that even large companies where cyber security is trusted, their approach to privacy may not be (e.g., many would trust Google or Facebook/Meta around preventing hacks, but not approve of how personal data might be used). For that reason, a purely privacy-preserving method like the one described is preferable.

### Evolutionary Analysis of Multi-Participant Cohorts for Adaptive Attribution Determination

Procedural determination and alteration of system attributes can be straight forward for single-entity systems. For example, in the case of training or education one may wish to determine the attributes of taught content after a student has completed prior work. In a simple example, a student takes a course and then completes an assessment to demonstrate mastery of the lesson. Then, the attributes of future course content might be based on a pre-determined learning path (e.g., after passing Calculus 1, the student proceeds to Calculus 2). This can, of course, be more complex, such as by incorporating detailed performance or other analytics, including cognitive analytics, on student performance such that future courses may result in a blend of content that supports teaching objectives specific to the student. Similarly, in gaming, a player may “level up” a character and increase a particular character “stat”, e.g., skill in fighting. Future leveling up of this skill, as well as gameplay challenge and content, and the selection of other skills that are available to the character at future levels (e.g., on a skill tree) may change based on the combination of current stats of the player and current or past choices. In both cases it is common to see adaptive selection of attributes based on the current and historical data of the individual. This can lead to dynamic changes, e.g., in gameplay, where the experience is determined by the actions of the individual, rather than a linear or pre-determined sequence of events or content. We note that attributes can be of the entity, such as the skill level of the individual or character, as well as of other aspects of the system, such as the environment or training content.

However, in the case of multi-participant scenarios (e.g., many students in a class or multiplayer games), there are only simplistic ways of determining how attributes should progress. This is often the case because all participants must generally see the same or similar content attributes or the attributes experienced are at least coherent across the individual experiences. This is often manifested in two ways. First, attributes are typically determined by some basic statistic of the participant cohort (e.g., the average, the min. or the max. of a particular characteristic such as prior choices or prior performance, which is quite common in education). Alternatively, the attributes, which may be dynamic, are siloed to the individual (e.g., only the skill-tree is adaptively determined, and is influenced only by the individual and not the cohort). In the case of more intelligent methods, it has conventionally been restricted to only using existing content building blocks in the very constrained environment of course learning paths and are limited to considering a single participant, not a cohort (i.e., solve only a simpler special case).

In general, prior solutions seek to optimize only the single-participant case, rather than the cohort, which is a substantially more complex problem where solutions are not obvious. Where a cohort is considered, the evolutionary population does not simply consider the behavior of a user; instead, it generally must consider several other factors. These additional factors may include, but are not limited to, the following: (1) characteristics and behaviors of the cohort members and their interaction (which, itself, may require a model); (2) changes across cohort members in addition to changes over time, such that the problem to be solved is jointly cross-sectional and longitudinal; and (3) evolutionary mechanisms that are meaningful for such a population. In the single member case, evolutionary mechanisms need only consider the individuals' choices or changes over time, and so ideal approaches are amenable to different algorithm choices and specifics. In the case of gameplay, simplistic approaches are often used to provide greater control over the game design and experience. Simplistic approaches are also used in gameplay to reduce overall complexity, such as for computational reasons or to meet system performance requirements. In such cases, games are forced to rely more heavily on the multiplayer interactions (i.e., the humans themselves) to provide new experiences, but those experiences are not tightly coupled to dynamic gameplay mechanics. Accordingly, what is needed is an improved method for altering system attributes for a cohort of participants.

Evolutionary algorithms, such as genetic algorithms, are mature and are commonly used to solve difficult optimization problems (e.g., the “Traveling Salesman” problem, complex scheduling of sports games against multiple constraints, placement of infrastructure, etc.). They have recently been proposed for use in determining optimal course paths for a single learner. However, conventionally, evolutionary algorithms have not been used in determining attributes (e.g., content or choices in training/games). Also, such approaches typically only consider the single user, not a more complex multiple participant cohort. Thus, the development of content using evolutionary algorithms has, conventionally, been carried out in a restricted manner. For example, such methods generally provide only an individual's learning path and are, typically, built exclusively from pre-existing content.

In this discussion, the term “cohort” is used to refer to multiple participants of an experience, such as game, a class/course, a training session, an event, a collaborative session, and the like, where participants are individual entities (i.e., human or otherwise) that interact with one another during the experience. Each entity is associated with a slate of characteristics, attributes, qualities, etc. First, characteristics define meaningful metrics, features, qualities, or quantities that are associated with an entity. Characteristics may, but are not required to, influence aspects of behaviors (e.g., how fast an entity moves in a game, or propensity to make certain decisions). Next, behaviors are the choices, actions, performance, decisions or other active or passive interactions the entity engages in. Finally, other interaction mechanics govern interactions that are not directly related to behaviors. For example, passive interactions between the experience's environment and an entity's characteristics (e.g., an entity having an allergy and the environment having the allergen). Finally, attributes are any aspect of the experience that are adaptive in the context of the proposed methods. Attributes may be content, such as the environment or enemies in a game, or hazards in a training scenario. It may be sound effects or visuals, interaction mechanics or even entity characteristics (e.g., a skill of a character in a game may also be a characteristic of the entity and be adaptive over the course of the game)

Evolutionary algorithms, such as genetic algorithms, are population-based approaches to optimization problems that utilize mechanisms inspired by evolutionary biology such as reproduction and mutation. Candidate solutions to the posed problem comprise the population, which is evolved through “generations” (i.e., iterations) via the evolutionary mechanisms. A fitness function provides a means of measuring the performance of a candidate solution, and thus may influence its propagation across subsequent generations.

In the present case, the evolutionary algorithm (or “EA”) seeks a function that optimally transforms some attribute or set of attributes from a current state to some desired future state. That transformation may be immediate (e.g., in a single application of the function), or after multiple iterations (e.g., multiple applications of the function). The optimal function may be any transformation, including a sequence of transformations (i.e., a function composed of multiple ordered or unordered subfunctions). Transformations can include the use or selection of existing outcomes, such as using existing content from a library when altering content attributes. Alternatively, it may make use of additional systems, such as generative systems, for generating new content without prior building blocks. Between the two extremes, atomic building blocks (i.e., not content but content pieces) could be used, where the transformation includes the assembly of such atomic pieces into content. The EA could conceivably result in the creation of its own generative methods as the optimal transformation. The example given above relies on the use of EAs but other methods, such as neural networks, etc., may also be used.

The input for the function is expected to be the characteristics and behaviors of the entities in the cohort, as well as any relevant input from other aspects of the experience and content (e.g., environment where the cohort is located). Interaction mechanics may be included as part of this input, such as models or mechanisms for how behaviors interact with the environment to provide subsequent (or derivative) input for the transformation function. For example, the EA may determine a function that, given the state of all inputs, provides the options for the skill tree of each member of the cohort as the character levels up. In this way, the skill tree choices become dependent on the characteristics and behaviors of the cohort (e.g., prior selection of skills in the tree by cohort members). This could also include a change of characteristics, such as transforming existing skills of a character, which then leads to feedback in how such characteristics influence the environment, behaviors, or other aspects of the experience.

It is noted that the method need not specify a transformation but may alternatively provide an optimal target for another optimization system. For example, in a system where training content is dynamically altered to optimize cognitive load, this system could provide a means of providing a recommended cognitive load to achieve a particular goal (e.g., optimize learning). Since training content in a shared environment needs to be consistent, it is often not possible to optimize each cohort member's cognitive load individually and simultaneously. While the actual optimization of the cognitive load may be handled by another system, the proposed system could provide the optimization objective that finds the near-optimal cognitive load for all cohort entities. Similar analogies can be found in other fields such as gaming (e.g., finding an optimal difficulty level) and education.

In general, EAs are used for optimization where the fitness function relates to one or more optimization objectives and associated constraints (if any). While the fitness function is a critical mechanism to allow the evolutionary mechanics to proceed, the optimization objective that this system attempts to achieve can be quite broad and ambiguous in practice. In fact, conceptually, it need not seek an optimum at all, depending on the specific implementation of the fitness function. The fitness function may simply provide measurements of concepts such as parsimony (e.g., simplicity of the transformation or targeted content), novelty (e.g., transformations that result in new attributes, for some definition of novelty), or even just random selection that relates to no specific objective (e.g., purely random, or weighted by something like prevalence in the population of candidates or other metric). For example, the goal of using this system might not be about optimization per se, but simply to introduce new and novel paths for skill trees (e.g., in the case of a game) or new paths for learning different topics (e.g., in the case of education) based on the group of participating entities.

Combinations of skills can be generated evolutionarily through mutation and recombination based on the current skills or knowledge of the cohort. The fitness function may have no optimization objective other than to allow generation of combinations, so it may simply randomly select candidate solutions for propagation from generation to generation. Alternatively, a fitness function may prioritize candidate solutions that are considered “novel,” such as not having been seen before (within the current experience or across prior experience sessions for these participants). One can imagine the same being used to generate novel enemies, weapons, quests, or other content in games and similarly for training/educational content.

Advantageously, the system and methods described above are applicable to multi-entity experiences where the entities interact during the experience, where such interactions are considered meaningful to the adaptive changes in attributes (e.g., content). Furthermore, while it is an option to do so, this solution makes no assumption of prior content; rather, it considers the dynamic generation of content or the building of content from atomic building blocks.

These methods allow for the generation of extremely dynamic content that is not only tailored to an individual, but to a cohort of entities. Importantly, each entity's characteristics, their behaviors (e.g., choices and actions), and their interactions (i.e., both in terms of how entities directly interact and how behaviors/characteristics interact in the overall system) are incorporated. This may, for example, allow the strengths of some entities to overcome the weaknesses of others and, thus, focus on developments for characteristics all entities are lacking (e.g., perhaps there is no need for content to support learning skills another cohort member has mastered). Preferably, the attributes determined and how they change may be optimized for the joint benefit of all entities and take into consideration constraints arising from individual entities, emergent from combination of entities or arising from other aspects (e.g., environment, system design, etc.). That is, the Pareto surface of the ideal attributes and attribute determining system can be found. It can also lead to emergent behavior in the system as it can introduce non-linearities from iterative interactions. For example, when adapting training content to optimize the cognitive load, training content may be generated to achieve the optimal (or a sub-optimal) state of some or all entities, but it may differ entirely from any content that would have been generated when considering only individual entities (or even a different cohort of entities).

For the class of problems solved, evolutionary approaches such as this are also computationally efficient and therefore appropriate for systems with limited compute or where performance is needed elsewhere, such as in games. Furthermore, these methods allow for greater variety in content (e.g., resulting from emergent behavior) and for a tighter coupling between the attributes (e.g., content) and the cohort's behaviors and characteristics. This is a unique mechanic that currently only exists to a limited extent for single entities (such as skill-tree development in games). This is useful not just for training and education, but also for games where dynamic content need not rely exclusively on user-generated content (e.g., player-to-player interactions) but can include, e.g., multiplayer-to-environment-to-player interactions. It could also be applied in non-playable entities within a game, such as allowing enemies to evolve based on interactions with each other and players, where enemy characteristics (e.g., the attributes in this case) can change and in turn impact enemy behavior (e.g., evolving higher damage or speed). Finally, these methods provide benefits to machine learning, such as reinforcement learning for intelligent agents. For example, the methods used by a cohort formed by cooperative and collaborative agents while learning in an environment might be adapted using these methods. This, in turn, may lead to more efficient policy learning over current methods as it can leverage the strengths of the individual agents jointly.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A method for generating XR content comprising:
performing a spatial abstraction of a first physical space having a first physical arrangement by identifying and representing portions of the first physical arrangement as a first group of one or more digital components, wherein the first group of one or more digital components is represented as code suitable for use by an XR generation system (XGS) to generate XR content for a plurality of physical spaces and a plurality of physical arrangements but that each include corresponding portions that may each be represented by the one or more digital components;
with an XGS, generating XR content for the corresponding portions of at least one physical space.

2. The method of claim 1 wherein the at least one physical space comprises the first physical space, such that the XR content is generated for the first physical space and the first physical arrangement.

3. The method of claim 1 wherein the at least one physical space does not comprise the first physical space, such that the XR content is generated for a physical space and a physical arrangement other than the first physical space and the first physical arrangement.

4. The method of claim 1 further comprising providing the XR content to a first user.

5. The method of claim 4 further comprising providing the XR content to the first user and to a second user that are each located in a co-located at least one physical space.

6. The method of claim 1 wherein XR content is generated for at least a first physical space and a second and different physical space.

7. The method of claim 6 further comprising providing the XR content to a first user located in the first physical space and a second user located in the second physical space.

8. The method of claim 1 further comprising providing one or more spatial modules that each govern an interaction with a digital component.

9. The method of claim 8 wherein the spatial modules comprise a library of pre-defined spatial modules that may each be selectively chosen and applied to each digital component when generating the XR content.

10. The method of claim 8 wherein the XGS automatically selects and applies a spatial module to at least one digital component.

11. The method of claim 8 wherein at least one of the plurality of spatial modules governs a baseline physical function of the digital component.

12. The method of claim 8 wherein at least one of the plurality of spatial modules governs a game mechanic function of the digital component.

13. The method of claim 1 further comprising using a scanner associated with the XGS to perform a three-dimensional scan of the first physical space prior to performing the spatial abstraction, and wherein the spatial abstraction is performed on the three-dimensional scan.

14. The method of claim 1 wherein the code comprises information related only to the one or more digital components and does not contain information related to a position or orientation of the first physical arrangement or a position or orientation of any other physical arrangement such that the one or more digital components are usable for each of the plurality of physical spaces and plurality of physical arrangements.

15. The method of claim 1 further comprising:
providing a plug comprising an encoding that is configured to store, retain, or allow retrieval of information; and
providing one or more receptacles that are each configured to accept the plug and that are each comprised of an interaction layer that governs an interaction between (1) the at least one physical space, a user, or a first portion of the XR content and (2) a second portion of the XR content.

16. The method of claim 15 wherein the encoding comprises at least one of:
a base layer defining an abstracted geometry of the at least one physical space and represented by the one or more digital components;
a dimensional layer for encoding spatial relationships of the one or more digital components of the encoding;
a semantic layer for providing semantic information of the one or more digital components of the encoding; or
a mechanic layer for providing spatial mechanic information specifying at least one of materials or behavior of the one or more digital components of the encoding.

17. The method of claim 16 wherein the mechanic layer of the plug fully matches the mechanic layer of the one or more receptacles such that an entirety of the at least one of materials or behavior specified by the mechanic layer of the one or more receptacles is accessible to the plug.

18. The method of claim 16 wherein:
the mechanic layer of the plug partially matches the mechanic layer of the one or more receptacles such that less than an entirety of the at least one of materials or behavior specified by the mechanic layer of the one or more receptacles is accessible to the plug; or
the mechanic layer of the one or more receptacles partially matches the mechanic layer of the plug such that less than an entirety of the at least one of materials or behavior specified by the mechanic layer of the plug is accessible to the one or more receptacles.

19. The method of claim 15 wherein at least one of the one or more receptacles comprises a mechanic layer for providing spatial mechanic information specifying at least one of materials or behavior of the one or more digital components of the encoding.

20. The method of claim 1 further comprising providing an interpreter configured to convert the one or more digital components to XR content suitable tailored for the at least one physical space.

21. The method of claim 20 further comprising:
with the interpreter, receiving a space-as-code (SAC) instruction for creating the XR content;
in generating the XR content and in response to the SAC instruction, using to the interpreter to translate the one or more digital components to corresponding physical equivalents; and
using the interpreter, identifying the corresponding physical equivalents in the at least one physical space and then generating the XR content based on the identified corresponding physical equivalents.

22. The method of claim 1 further comprising:
communicating data to a user located at a selected space of the at least one physical space;
modifying the data or communication of the data communicated to the user based on the selected space.

23. The method of claim 22 wherein the data is the XR content generated by the XGS.

24. The method of claim 22 wherein the data or communication of the data is dynamically modified based on the selected space in real time.

25. A system for generating and providing XR content to a user comprising:
an XR generation system (XGS) configured to:
perform a spatial abstraction of a first physical space having a first physical arrangement by identifying and representing portions of the first physical arrangement as a first group of one or more digital components, wherein the first group of one or more digital components is represented as code suitable for use by an XR generation system (XGS) to generate XR content for a plurality of physical spaces and a plurality of physical arrangements but that each include corresponding portions that may each be represented by the one or more digital components;
using the code, generate XR content for the corresponding portions of at least one physical space; and
an XR system configured to output the XR content to a user.

26. A method for generating XR content comprising:
providing a plurality of physical spaces, each with spatial elements having a known spatial relationship relative to one another including one or more of a position or orientation;
performing a spatial abstraction of a first physical space of the plurality of physical spaces by identifying and representing a first pair of the spatial elements, including the known spatial relationship, as a digital component, wherein the digital component comprises code suitable for use by an XR generation system (XGS) to generate XR content tailored for and representative of pairs of spatial elements in the plurality of physical spaces having a spatial relationship that corresponds to the spatial relationship of the first pair of spatial elements, including at least in a pair of physical spaces that have different physical arrangements;
identifying a second pair of spatial elements having a spatial relationship corresponding to the spatial relationship of the first pair of spatial elements in a second physical space of the plurality of physical spaces,
with an XGS, generating XR content that is tailored for the second physical space of the plurality of physical spaces by using the digital component to represent the second pair of spatial elements.

27. The method of claim 26 wherein the second physical space comprises the first physical space, such that the XR content is generated for the first physical space and a first physical arrangement of the first physical space.

28. The method of claim 26 wherein the second physical space does not comprise the first physical space, such that the XR content is generated for a physical space and a physical arrangement other than the first physical space and a first physical arrangement of the first physical space.

29. The method of claim 26 wherein XR content is generated for at least the pair of physical spaces that have different physical arrangements using the digital component.

30. The method of claim 26 wherein the digital component comprises one or more digital components that are each associated with a pair of spatial elements having a known spatial relationship relative to one another including one or more of a position and orientation, the method further comprising providing one or more spatial modules that are each reusable and that each govern an interaction between the XR content generated by the XGS and one of the one or more digital components.

31. The method of claim 26 wherein the code comprises information related only to the digital component and does not contain information related to a position or orientation of the first physical arrangement or a position or orientation of any other physical arrangement such that the digital component is usable for each of the plurality of physical spaces and plurality of physical arrangements.

32. The method of claim 26 further comprising:
providing a two-part encoding that governs the XR content that is generated by the XGS for each of the plurality of physical spaces, the encoding formed by:
a first encoding half that is based on the first digital component and that lacks data related to any of the plurality of physical spaces; and
one or more second encoding halves that are each configured to pair with the first encoding half, and are each configured to store, retain, or allow retrieval of information about one of the plurality of physical spaces,
wherein, when the first encoding half is paired with one of the one or more second encoding halves to define an encoding pair, the XGS generates XR content that is determined based on the encoding pair.

33. The method of claim 32 wherein the encoding comprises at least one of:
a base layer defining an abstracted geometry of one of the plurality of physical spaces;
a dimensional layer for encoding one or more spatial relationships of the one physical space of the plurality of physical spaces;
a semantic layer for providing semantic information of the one physical space of the plurality of physical spaces; or
a mechanic layer for providing spatial mechanic information specifying at least one of materials or behavior of the one physical space of the plurality of physical spaces.

34. The method of claim 26 wherein each of the pairs of spatial elements have a semantic relationship relative to one another, the method further comprising performing a spatial abstraction on the first physical space of the plurality of physical spaces by identifying and representing the pair of spatial elements of the first physical space, including the known spatial relationship and the known semantic relationship, as the first digital component.

35. A system for generating and providing XR content to a user comprising:
an XR generation system (XGS) configured to:
perform a spatial abstraction of a first physical space of a plurality of physical spaces, each with spatial elements having a known spatial relationship relative to one another including one or more of a position or orientation, by identifying and representing a first pair of the spatial elements, including the known spatial relationship, as a digital component, wherein the digital component comprises code suitable for use by an XR generation system (XGS) to generate XR content tailored for and representative of pairs of spatial elements in the plurality of physical spaces having a spatial relationship that corresponds to the spatial relationship of the first pair of spatial elements, including at least in a pair of physical spaces that have different physical arrangements;
identify a second pair of spatial elements having a spatial relationship corresponding to the spatial relationship of the first pair of spatial elements in a second physical space of the plurality of physical spaces,
using the code, using the XGS to generate XR content that is tailored for the second physical space of the plurality of physical spaces by using the digital component to represent the second pair of spatial elements; and
an XR system configured to output the XR content to a user.
